(19) United States
(12) Patent Application Publication
(10) Pub. No.: US 2024/0159785 A1
(43) Pub. Date: May 16, 2024

(54) TECHNIQUES FOR DIAGNOSING SOURCES OF ERROR IN A SAMPLE PROCESSING WORKFLOW

(71) Applicant: Invitae Corporation, San Francisco, CA (US)

(72) Inventors: Emil Ragip Keyder, Brooklyn, NY (US); Garett Scott Bernstein, Somerville, MA (US)

(73) Assignee: Invitae Corporation, San Francisco, CA (US)

(21) Appl. No.: 18/559,553

(22) PCT Filed: Jul. 1, 2022
(86) PCT No.: PCT/US2022/035901

§ 371 Date: Nov. 7, 2023

Related U.S. Application Data
(60) Provisional application No. 63/218,177, filed on Jul. 2, 2021.

(51) Int. Cl. G01N 35/00

(52) U.S. Cl. CPC G01N 35/00613

(57) ABSTRACT

Techniques for identifying sources of error occurring during processing of biological samples in a laboratory environment. The techniques may include obtaining data about the biological samples, where the data is generated by processing the biological samples in accordance with a sample processing workflow. The sample processing workflow is performed using physical component(s) and/or workflow process(es). The techniques further include determining values of quality metric(s) associated with the sample processing workflow for the biological samples, identifying source(s) of error for the data by using the values of the quality metric(s) and statistical model representing causal relationships among the physical component(s) and the workflow process(es), and outputting information indicative of the identified source(s) of error.

### CROSS-REFERENCE TO RELATED APPLICATION

This application claims the benefit of priority under 35 U.S.C. § 119(e) to U.S. Provisional Patent Application Ser. No. 63/218,177, filed on Jul. 2, 2021, titled “TECHNIQUES FOR DIAGNOSING SOURCES OF ERROR IN A SAMPLE PROCESSING WORKFLOW”, which is incorporated by reference herein in its entirety.

### FIELD

Aspects of the technology described herein relate to techniques for diagnosing sources of error in a sample processing workflow.

### BACKGROUND

Processes (e.g., biological sample processing, manufacturing, chemical pipeline) performed in a laboratory environment to obtain some result may involve performing different steps in a workflow using different pieces of equipment, reagents, and other materials. Problems can arise at any one of these workflow steps that can impact quality and accuracy of the results. In the context of processing a biological sample, a sequencing workflow may involve performing different steps (e.g., extraction, amplification, hybridization, sequencing) using different pieces of equipment (e.g., sequencing machine, hybridization machine), reagents (e.g., buffers, bait mix, PCR master mix), and other materials (e.g., flow cell, pipette, cartridge, sample tube) to obtain sequencing results.

### SUMMARY

Some embodiments relate to a method for identifying sources of error occurring during processing of biological samples in a laboratory environment in accordance with a sample processing workflow, the sample processing workflow being performed using one or more physical components and/or one or more workflow processes, the sample processing workflow being associated with at least one quality metric. The method comprises using at least one computer hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more sources of error for the data generated by processing the plurality of biological samples, the identifying performed using the values of the at least one quality metric and a statistical model representing causal relationships among the one or more physical components and/or the one or more workflow processes used to perform the sample processing workflow; and outputting information indicative of the identified one or more sources of error.

Some embodiments relate to a system for identifying sources of error occurring during processing of biological samples in a laboratory environment in accordance with a sample processing workflow, the sample processing workflow being performed using one or more physical components and/or one or more workflow processes, the sample processing workflow being associated with at least one quality metric. The system comprises at least one hardware processor; and at least one non-transitory computer-readable storage medium storing processor-executable instructions that, when executed by the at least one hardware processor, cause the at least one hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more sources of error for the data generated by processing the plurality of biological samples, the identifying performed using the values of the at least one quality metric and a statistical model representing causal relationships among the one or more physical components and/or the one or more workflow processes used to perform the sample processing workflow; and outputting information indicative of the identified one or more sources of error.

Some embodiments relate to at least one non-transitory computer-readable storage medium storing processor-executable instructions that, when executed by at least one hardware processor, cause the at least one hardware processor to perform a method for identifying sources of error occurring during processing of biological samples in a laboratory environment in accordance with a sample processing workflow, the sample processing workflow being performed using one or more physical components and/or one or more workflow processes, the sample processing workflow being associated with at least one quality metric. The method comprises using at least one computer hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more sources of error for the data generated by processing the plurality of biological samples, the identifying performed using the values of the at least one quality metric and a statistical model representing causal relationships among the one or more physical components and/or the one or more workflow processes used to perform the sample processing workflow; and outputting information indicative of the identified one or more sources of error.

Some embodiments relate to a method for identifying attributes for one or more physical components and/or one or more workflow processes of a sample processing workflow, the sample processing workflow being performed using the one or more physical components and/or the one or more workflow processes, the sample processing workflow being associated with at least one quality metric. The method comprises using at least one computer hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more attributes for the one or more physical components and/or the one or more workflow processes, the identifying performed using the values of the at least one quality metric and a graphical model comprising nodes representing random variables corresponding to the one or more physical components and/or the one or more workflow processes, each of at least some of the nodes representing a random variable whose value is indicative of a degree to which a physical component or a workflow process contributed to error in the data generated by processing the plurality of biological samples in accordance with the sample processing workflow; and outputting information indicative of the identified one or more attributes.

Some embodiments relate to a system for identifying conditions for one or more physical components and/or one or more workflow processes of a sample processing workflow, the sample processing workflow being performed using the one or more physical components and/or the one or more workflow processes, the sample processing workflow being associated with at least one quality metric. The system comprises at least one hardware processor and at least one non-transitory computer-readable storage medium storing processor-executable instructions that, when executed by the at least one hardware processor, cause the at least one hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more attributes for the one or more physical components and/or the one or more workflow processes, the identifying performed using the values of the at least one quality metric and a graphical model comprising nodes representing random variables corresponding to the one or more physical components and/or the one or more workflow processes, each of at least some of the nodes representing a random variable whose value is indicative of a degree to which a physical component or a workflow process contributed to error in the data generated by the sample processing workflow; and outputting information indicative of the identified one or more attributes.

Some embodiments relate to at least one non-transitory computer-readable storage medium storing processor-executable instructions that, when executed by at least one hardware processor, cause the at least one hardware processor to perform a method for identifying conditions for one or more physical components and/or one or more workflow processes of a sample processing workflow, the sample processing workflow being performed using the one or more physical components and/or the one or more workflow processes, the sample processing workflow being associated with at least one quality metric. The method comprises obtaining data about a plurality of biological samples, the data generated by processing the plurality of biological samples in accordance with the sample processing workflow; determining, using the data, values of the at least one quality metric for each of at least some of the plurality of biological samples; identifying one or more attributes for the one or more physical components and/or the one or more workflow processes, the identifying performed using the values of the at least one quality metric and a graphical model comprising nodes representing random variables corresponding to the one or more physical components and/or the one or more workflow processes, each of at least some of the nodes representing a random variable whose value is indicative of a degree to which a physical component or a workflow process contributed to error in the data generated by the sample processing workflow; and outputting information indicative of the identified one or more attributes.

Some embodiments relate to a method for monitoring attributes of one or more physical components and/or one or more workflow processes used in performing a sample processing workflow, the sample processing workflow being associated with at least one quality metric. The method comprises using at least one computer hardware processor to perform: obtaining first data about a first plurality of biological samples, the first data generated by processing the first plurality of biological samples in accordance with the sample processing workflow; determining, using the first data, first values of the at least one quality metric for each of at least some of the first plurality of biological samples; identifying, using the first values of the at least one quality metric and a statistical model, one or more first attributes for the one or more physical components and/or the one or more workflow processes; obtaining second data about a second plurality of biological samples, the second data generated by processing the second plurality of biological samples in accordance with the sample processing workflow; determining, using the second data, second values of the at least one quality metric for each of at least some of the second plurality of biological samples; identifying, using the second values of the at least one quality metric and the statistical model, one or more second attributes for the one or more physical components and/or the one or more workflow processes; and detecting a change in a physical component or a workflow process of the sample processing workflow based on the identified one or more first attributes and the identified one or more second attributes.

Some embodiments relate to a system for monitoring attributes of one or more physical components and/or one or more workflow processes used in performing a sample processing workflow, the sample processing workflow being associated with at least one quality metric. The system comprising at least one hardware processor and at least one non-transitory computer-readable storage medium storing processor-executable instructions that, when executed by the at least one hardware processor, cause the at least one hardware processor to perform: obtaining first data about a first plurality of biological samples, the first data generated by processing the first plurality of biological samples in accordance with the sample processing workflow; determining, using the first data, first values of the at least one quality metric for each of at least some of the first plurality of biological samples; identifying, using the first values of the at least one quality metric and a statistical model, one or more first attributes for the one or more physical components and/or the one or more workflow processes; obtaining second data about a second plurality of biological samples, the second data generated by processing the second plurality of biological samples in accordance with the sample processing workflow; determining, using the second data, second values of the at least one quality metric for each of at least some of the second plurality of biological samples; identifying, using the second values of the at least one quality metric and the statistical model, one or more second attributes for the one or more physical components and/or the one or more workflow processes; and detecting a change in a physical component or a workflow process of the sample processing workflow based on the identified one or more first attributes and the identified one or more second attributes.

Some embodiments relate to at least one non-transitory computer-readable storage medium storing processor-executable instructions that, when executed by at least one hardware processor, cause the at least one hardware processor to perform a method for monitoring attributes of one or more physical components and/or one or more workflow processes used in performing a sample processing workflow, the sample processing workflow being associated with at least one quality metric. The method comprising: obtaining first data about a first plurality of biological samples, the first data generated by processing the first plurality of biological samples in accordance with the sample processing workflow; determining, using the first data, first values of the at least one quality metric for each of at least some of the first plurality of biological samples; identifying, using the first values of the at least one quality metric and a statistical model, one or more first attributes for the one or more physical components and/or the one or more workflow processes; obtaining second data about a second plurality of biological samples, the second data generated by processing the second plurality of biological samples in accordance with the sample processing workflow; determining, using the second data, second values of the at least one quality metric for each of at least some of the second plurality of biological samples; identifying, using the second values of the at least one quality metric and the statistical model, one or more second attributes for the one or more physical components and/or the one or more workflow processes; and detecting a change in a physical component or a workflow process of the sample processing workflow based on the identified one or more first attributes and the identified one or more second attributes.

### BRIEF DESCRIPTION OF DRAWINGS

Various aspects and embodiments will be described with reference to the following figures. The figures are not necessarily drawn to scale.

FIG. 1 is a diagram of an illustrative process for identifying sources of error occurring during processing of biological samples in a laboratory environment in accordance with a sample processing workflow, in accordance with some embodiments of the technology described herein.

FIG. 2 is a schematic of a graphical model used for identifying sources of error in a sample processing workflow, in accordance with some embodiments of the technology described herein.

FIG. 3 shows example values for sequencing quality metrics and source of error probabilities for different nodes of the graphical model shown in FIG. 2, in accordance with some embodiments of the technology described herein.

FIG. 4A an example schematic illustrating how plate notation is used in visualizing a graphical model, in accordance with some embodiments of the technology described herein.

FIG. 4B is a schematic illustrating the separate nodes corresponding to the plate notation used in FIG. 4A, in accordance with some embodiments of the technology described herein.

FIG. 5 shows an example of using plate notation for the graphical model shown in FIG. 2, in accordance with some embodiments of the technology described herein.

FIG. 6A shows example values for sequencing quality metrics and source of error probabilities for some of the nodes in the graphical model shown in FIG. 2, in accordance with some embodiments of the technology described herein.

FIG. 6B shows example values for sequencing quality metrics and source of error probabilities for some of the nodes in the graphical model shown in FIG. 2, in accordance with some embodiments of the technology described herein.

FIG. 7 is a schematic of an example graphical model representing causal relationships for next-generation sequencing processing workflow, in accordance with some embodiments of the technology described herein.

FIG. 8 is a schematic of an example graphical model representing causal relationships for SARS-CoV-2 diagnostic testing workflow, in accordance with some embodiments of the technology described herein.

FIG. 9 is a flow chart of an illustrative process for identifying sources of error occurring during processing of biological samples in a laboratory environment in accordance with a sample processing workflow, in accordance with some embodiments of the technology described herein.

FIG. 10 is a flow chart of an illustrative process for identifying attribute(s) for physical component(s) and/or workflow process(es) of a sample processing workflow, in accordance with some embodiments of the technology described herein.

FIG. 11 is a flow chart of an illustrative process for monitoring attributes of physical component(s) and/or workflow process(es) used in performing a sample processing workflow, in accordance with some embodiments of the technology described herein.

FIG. 12 is a plot of mean bait coverage vs. sample health and is an example logistic transformation, in accordance with some embodiments of the technology described herein.

FIG. 13A is a confusion matrix comparing true sequenced sample status to predicted sequenced sample status determined using a statistical model, in accordance with some embodiments of the technology described herein.

FIG. 13B is a plot of true sequenced sample status vs. predicted sequenced sample status determined using a statistical model, in accordance with some embodiments of the technology described herein.

FIG. 14 is a plot of predicted enriched library vs. predicted raw sample determined using a statistical model, in accordance with some embodiments of the technology described herein.

FIG. 15A is a plot of predicted enriched library vs. predicted raw sample for only samples that passed sequencing determined using a statistical model, in accordance with some embodiments of the technology described herein.

FIG. 15B is a plot of predicted enriched library vs. predicted raw sample for only samples that failed sequencing determined using a statistical model, in accordance with some embodiments of the technology described herein.

FIG. 16 is a plot of health status for different bait reagents determined using a statistical model, in accordance with some embodiments of the technology described herein.

FIG. 17 is a plot of health status for different bait reagents determined using a statistical model, in accordance with some embodiments of the technology described herein.

FIG. 18 is a plot of health status for different hybridization machines determined using a statistical model, in accordance with some embodiments of the technology described herein.

FIG. 19 is a block diagram of an illustrative computer system that may be used in implementing some embodiments of the technology described herein.

FIG. 20 is a screen shot of an example user interface for visualizing health status of one or more workflow entities (e.g., a physical component(s) and/or workflow process(es)) over time, in accordance with some embodiments of the technology described herein.

FIGS. 21-23 show an example of a graphical user interface used for modeling a sequencing workflow and for viewing potential sources of error upstream from a particular workflow entity (e.g., a physical component and/or workflow process), in accordance with some embodiments of the technology described herein.

FIG. 24 shows an example of graphical user interface that enables a user to view effects of a problem with a particular workflow entity (e.g., a physical component and/or workflow process) downstream of that particular workflow entity, in accordance with some embodiments of the technology described herein.

FIG. 25 is a screen shot of another example user interface for visualizing the health status of one or more workflow entities over time, in accordance with some embodiments of the technology described herein.

### DETAILED DESCRIPTION

A biological sample may be processed in accordance with a sample processing workflow in a laboratory environment. As part of the sample processing workflow, the biological sample may interact with numerous different physical components of the laboratory environment and different workflow processes may be performed on the biological sample. For example, a sample processing workflow for sequencing a biological sample may involve a nucleic acid extraction process, an enrichment process, and a sequencing process. During the extraction process, the biological sample may interact with multiple reagents, including different types of buffers, and an extraction machine. The enrichment process may involve an extracted biological sample interacting with various types of reagents, including a bait mix, enrichment beads, buffers, and primer mixes, as wells as a thermocycler and automation system. Additionally, during the sequencing process, an enriched biological sample may interact with other physical components, including a flow cell, sample tubes, more reagents, and a sequencing machine.

When results obtained by performing a sample processing workflow are of poor quality or are inaccurate, it can be challenging to assess what aspects of the sample processing workflow caused or contributed to the undesirable results because of the complexity of the sample processing workflow in a real-life laboratory environment. For example, there may be a failure in a piece of equipment, an expired lot of reagent, a defect in a flow cell, or the initial biological sample may be of poor quality. Since each of these may be possible sources of error in the same sample processing workflow, it is challenging to pinpoint which of them is an actual source of error when undesirable results are obtained by processing biological samples using the sample processing workflow.

The conventional approach to identifying a source of error involves having one or more people investigate the many physical components used in the sample processing workflow to assess what may have caused the error. This is a time-consuming task because there is little to no helpful information that narrows down the many physical components employed in a sample processing workflow to a list of possible candidates for sources of error. Moreover, once a source of error is identified and the issue is addressed, a diagnostic run through some or all the sample processing workflow may need to be performed to confirm that the sample processing workflow is operating as expected. Often the biological sample may need to be rerun through the sample processing workflow after issues are addressed so that any errors caused by them are resolved. Such diagnostic runs and reruns of biological samples lead to further waste of resources and increase laboratory operating costs. Furthermore, in some instances, the biological sample itself may have poor quality and a new sample may be needed. This may involve contacting the subject to ask them to provide a new sample. However, time and resources are frequently wasted in this situation if the focus of error diagnosis is on the physical components used in processing the biological sample rather than on getting a new sample. The time and resources would have been spent better on processing other biological samples.

The inventors have recognized that quality metrics associated with a sample processing workflow may be used to identify sources of error occurring during processing of biological samples in a laboratory environment in accordance with the sample processing workflow. A sample processing workflow may be associated with one or multiple quality metrics computed at one point in the workflow (e.g., at the end) or at multiple points during the workflow (e.g., after certain steps are performed but before other steps are performed). As an example of the latter, a sample processing workflow may include one or more workflow processes and one or more quality metrics may be computed for one or more of the workflow processes. For example, a next-generation sequencing (NGS) sample processing workflow may include multiple workflow processes such as an extraction process, a library preparation process, an enrichment process, and a sequencing process, and one or more quality metrics may be associated with each of one or more of these workflow processes. One example of a quality metric associated with the sequencing process (part of an NGS sample processing workflow) is cluster density, which indicates the number of clusters per unit area on a lane of a flow cell used during sequencing (e.g., ILLUMINA™ sequencing).

In some instances, one or more quality metrics may be computed from data generated during one or more stages of processing a biological sample using a sample processing workflow and/or from data generated at the end of the sample processing workflow. For example, a NGS sample processing workflow may include different stages of sample preparation before a sequencing process is used to obtain sequencing results. The different stages of sample preparation may include using an extraction process to obtain an extracted sample, using a library preparation process to obtain an unenriched sample, and using an enrichment process to obtain an enriched sample. The enriched sample may be sequenced to obtain sequencing results. One or more quality metrics may be computed from data generated during one or more of these stages and/or from the sequencing results. An example of a quality metric computed from data obtained from the extracted sample is A₂₆₀/A₂₈₀, which is the ratio of absorbance of ultraviolet light at 260 nm and 280 nm for a sample; the ratio serves as an indicator of sample purity or whether a sample is considered to be “clean” and suitable for downstream applications. Another example of a quality metric associated with the extracted sample is A₂₆₀/A₂₃₀, which is the ratio of absorbance of ultraviolet light at 260 nm and 230 nm for a sample; the ratio serves as another indicator of sample purity. An example quality metric computed from the sequencing results is AT dropout, which is a measure of how regions with low GC content are undercovered relative to mean coverage. Another example quality metric computed from the sequencing results is mean bait coverage, which is the mean coverage of all baits used.

In some embodiments, one or more quality metrics computed in application downstream from sequencing may be used to identify sources of error occurring during processing of biological samples in a laboratory environment in accordance with the sample processing workflow. For example, one or more quality metrics may be derived based on performance of downstream alignment and/or variant calling application. As one example, the sequence reads produced by the sample processing workflow may be aligned to a reference and the confidence in the resulting alignment may provide an indication that an error occurred during the sequencing workflow. For example, if the confidence in the resulting alignment is low, this may be indicative of an error having occurred during the sample processing workflow. Thus, the confidence produced by an alignment algorithm may be used as a quality metric, in some embodiments. As another example, if during variant calling, a variant that is expected to be present (e.g., because the sample is coming from a person previously sequenced and for whom the presence of that variant is known and expected, for example, during monitoring of disease progression) is not identified, that may provide an indication that an error occurred during the sample processing workflow.

In some embodiments, one or more quality metrics determined based on measurements obtained by one or more sensors may be incorporated into the statistical models described herein. Examples of such sensors include optical sensors (e.g., cameras to determine how a liquid was aliquoted from a tube), infrared sensors, temperature sensors, humidity sensors, or any other environmental sensors.

In some embodiments, quality metrics may be used to classify results of processing biological samples based on values determined for the quality metrics. For instance, a value for a quality metric may be compared to a threshold value to determine if the results associated with the value can be considered as having “failed” or “passed.” For example, mean bait coverage is one type of sequencing metric and, if a value for mean bait coverage associated with sequencing results is less than 300, then the sequencing results may be considered to have “failed.” When multiple quality metrics are used for evaluating results from a sample processing workflow, each of those quality metrics may be considered in turn. For example, if any one of the quality metrics is considered to have failed, then the results are determined to have failed. As an example, A₂₆₀/A₂₈₀ and A₂₆₀/A₂₃₀ are quality metrics associated with an extracted sample. In some instances, if either A₂₆₀/A₂₈₀ or A₂₆₀/A₂₃₀ is below 1.8, the sample may be considered to not be sufficiently clean and to have “failed.” As another example, if the majority of quality metrics passed (but not all of the quality metrics passed), the results are determined to have passed. Other voting schemes or ways of combining quality metric results may be employed including, for example, by aggregating quality metric results to determine a value of an aggregated quality metric (as described herein) and using the aggregated quality metric to determine whether the results have “passed” or “failed.”

The inventors have also recognized that values for quality metrics alone may provide a limited assessment of a sample processing workflow because the quality metrics are often associated with only some aspects of the workflow (e.g., there is not necessarily some intermediate readout available to monitor status of each physical component and/or workflow process along the way in the overall sample processing workflow). To address this limitation, the inventors have developed techniques that allow for parts of a sample processing workflow that lack any quality metric to be assessed as being possible error sources. For example, the inventors have developed statistical models (e.g., graphical models, for example, Bayesian networks) that represent causal relationships among physical components and workflow processes of a sample processing workflow. Each such statistical model may be designed for a specific sample processing workflow (e.g., one statistical model may be designed for a sample processing workflow for NGS and another statistical model may be designed for a sample processing workflow for SARS-CoV-2 testing). In addition, values of quality metrics for multiple different biological samples (e.g., 100 biological samples, 1,000 biological samples, 10,000 biological samples, between 1,000-5,000 biological samples, between 5,000-10,000 biological samples, between 10,000-50,000 biological samples, between 50,000-100,000 biological samples, between 100,000-1,000,000 biological samples, between 1,000,000-10,000,000 biological samples) processed in accordance with a sample processing workflow may be used with a statistical model for the workflow to generate meaningful statistics that may be used to identify sources of error in the sample processing workflow.

As an example, a sample processing workflow used for sequencing biological samples may include two sequencing machines: Sequencing Machine 1 and Sequencing Machine 2. If some or all of the biological samples processed using Sequencing Machine 2 are considered to have failed, then Sequencing Machine 2 may be identified as a source of error. For example, suppose 1,000 biological samples are sequenced using the sample processing workflow and are split between the two sequencing machines such that 500 biological samples are processed using Sequencing Machine 1, and 500 biological samples are processed using Sequencing Machine 2. Sequencing results for 400 of the 500 biological samples processed using Sequencing Machine 2 are considered to have failed based on one or more sequencing metrics, while only 100 of the 500 biological samples processed using Sequencing Machine 1 are considered to have failed. Based on these statistics, it can be determined that Sequencing Machine 2 disproportionately generates failed sequencing results and may be identified as a source of error in the sample processing workflow.

However, if the rate of failure among the biological samples is statistically uncorrelated with the two sequencing machines, then the sequencing machines may not be considered as sources of error. Instead, another aspect of the sample processing workflow or the biological samples themselves may be considered as a source or sources of error. Returning to the above example, if 300 of the 500 biological samples processed using Sequencing Machine 1 are considered to have failed and 200 of the 500 biological samples processed using Sequencing Machine 2 are considered to have failed, then 500 of the 1,000 biological samples have failed, but this may not be strong evidence indicating that either Sequencing Machine 1 or Sequencing Machine 2 is a source of error. Rather, the 500 biological samples that have failed may be because the samples themselves have poor quality or some other problem causing failure. In such a case, these biological samples may be considered as being a source of error.

Another way of using the techniques described herein to identify sources of error in a laboratory process may involve taking multiple portions of a single sample and running each of these portions through the laboratory process. If the techniques described herein detect errors occurring for each of the sample portions, this may indicate that the underlying problem is with the original sample itself. On the other hand, when errors only occur for some of the sample portions, but not others, this may indicate the source of errors is not the original sample, but one or more physical components and/or workflow processes employed as part of the laboratory process.

As the above examples illustrate, using many biological samples may allow for the identification of sources of error in a sample processing workflow that would otherwise be challenging to identify when considering a single biological sample. The statistical models described herein may be used for identifying sources of error by using quality metric values computed for multiple biological samples. In some embodiments, the quality metric values may include a value for a specific quality metric for each of the biological samples. For instance, if mean bait coverage is a quality metric used in the above examples, then there may be 1,000 values for mean bait coverage where each value is computed for a respective one of the 1,000 biological samples (e.g., from data generated during the sample processing workflow for that biological sample). By using quality metric values computed for many biological samples, a statistical model as described herein may be used to identify a physical component and/or a workflow process as being a source of error based on how statistics for those quality metric values propagate through causal relationships among physical components and workflow processes used in the sample processing workflow.

Accordingly, in some embodiments, a statistical model (e.g., a graphical model, for example, a Bayesian network) representing causal relationships among one or more physical components and/or one or more workflow processes used to perform a sample processing workflow may be used to identify one or more sources of error in the sample processing workflow. Data about biological samples processed in accordance with the sample processing workflow may be used to determine values for one or more quality metrics for the biological samples. In some embodiments, identifying sources of error involves using the statistical model and the values for the quality metric(s), for example, by inferring the posterior distributions of random variables in the model based on the values for the metric(s). In some embodiments, a physical component (e.g., piece of equipment, reagent) used to perform part of the sample processing workflow may be identified as a source of error. In some embodiments, a workflow process (e.g., an extraction process, a sequencing process) that is part of the sample processing workflow may be identified as a source of error.

According to the techniques described herein, a physical component or a workflow process that does not have any quality metrics associated with it may be identified as a source of error. This has the benefit of being able to consider all aspects of a sample processing workflow when diagnosing sources of error, even if quality metrics are computed for only some of the physical components and/or workflow processes used in the sample processing workflow. For example, quality metrics used for identifying sources of error in a NGS sample processing workflow may include one or more sequencing metrics associated with a sequencing process, but no quality metrics associated with an enrichment process performed prior to the sequencing process. However, the techniques described herein allow for identifying whether the enrichment process is a source of error indirectly by using values for the sequencing metrics and a statistical model that models causal relationships between the enrichment and sequencing processes. In this way, the techniques described herein allow for identifying sources of error indirectly by determining values for quality metrics based on processing data generated downstream of a possible source of error and using the statistical model to identify, using the downstream quality metrics, whether the possible source of error is likely to be an actual source of error.

In some embodiments, a physical component, from among the physical component(s) used to perform the sample processing workflow, may be identified as a source of error for the data. The physical component may be a piece of equipment used to perform one or more workflow processes of the sample processing workflow. In some embodiments, if the physical component is identified as a source of error using the techniques described herein, a person may assess the piece of equipment and determine if it needs repair. In some instances, the piece of equipment may be put out of service and removed from further processing of biological samples until it is fixed or otherwise placed in suitable condition.

In some embodiments, the physical component may be a reagent from a lot used to perform the sample processing workflow. The lot may be identified as being a source of error using the techniques described herein. In some embodiments, if the lot is identified as a source of error using the techniques described herein, the lot may be disposed of and not used for further processing of biological samples. This has the benefit of not using reagents from a lot known to be a source of error.

In some embodiments, one or more of the biological samples may be identified as a source of error using the techniques described herein. For example, a biological sample may have poor quality which may result in a source of error for results obtained for the biological sample. A new biological sample may need to be obtained from a subject and processed in accordance with the sample processing workflow. The ability to identify specific biological samples as being sources of error provides the benefit of ruling out any physical component used in the sample processing workflow as possible source of error, reducing operational costs for the laboratory.

Some embodiments described herein address all of the above-described issues that the inventors have recognized with identifying sources of error occurring during processing of biological samples in a laboratory environment. However, not every embodiment described herein addresses every one of these issues, and some embodiments may not address any of them. As such, it should be appreciated that embodiments of the technology described herein are not limited to addressing all or any of the above-described issues with identifying sources of error occurring during processing of biological samples in a laboratory environment.

Some embodiments involve identifying sources of error occurring during processing of biological samples in a laboratory environment in accordance with a sample processing workflow. The sample processing workflow may be performed using physical component(s) and/or workflow process(es). Data about biological samples may be obtained, where the data is generated by processing the biological samples in accordance with the sample processing workflow. Value(s) of the quality metric(s) for each of some or all of the biological samples may be determined using the data. Source(s) of error for the data may be identified by using the value(s) of the quality metric(s) and a statistical model representing causal relationships among the physical component(s) and/or the workflow process(es) used to perform the sample processing workflow. Information indicative of the identified source(s) of error may be output. In some embodiments, information indicative of the identified source(s) of error may be displayed to a user.

The physical component(s) may include pieces of equipment, reagents, and other materials. The physical component(s) may include an extraction machine, an extraction automation system, a library preparation automation system, a thermocycler, an automation system, a sequencing machine, a hybridization machine, a centrifugation machine, a liquid handling system, and a qPCR machine. The physical component(s) may include a buffer, a binding buffer, a wash buffer, an organic reagent, an inorganic reagent, an acidic solution, and a basic solution. In some embodiments, the physical component(s) may include a bait mix, a hybridization mix, a sequencing mix, a PCR master mix, and a primer mix. In some embodiments, the physical component(s) may include an enzyme, a labeled nucleotide, a sample plate, enrichment beads, a flow cell, a cartridge, a pipette, a pipette tip, and a sample tube.

The workflow process(es) may include an extraction process, a library preparation process, an enrichment process, a hybridization process, a sequencing process, a centrifugation process, an assay setup process, an amplification process, and a qPCR process.

Causal relationships represented by the statistical model may depend on the types of physical component(s) and/or the workflow process(es). For example, in embodiments where a sequencing process is part of a sample processing workflow, the physical component(s) may include one or more sequencing machines and one or more sequencing reagents, the data may include sequencing data for the biological samples, and the quality metric(s) may include sequencing metrics for the sequencing data. A statistical model according to the techniques described herein may represent causal relationships among the one or more sequencing machines, the one or more sequencing reagents, the biological samples, and the sequencing data.

As another example, in embodiments where a hybridization process is part of a sample processing workflow, the physical component(s) may include one or more hybridization reagents and one or more hybridization machines. A statistical model according to the techniques described herein may represent causal relationships among the one or more hybridization reagents, the one or more hybridization machines, the biological samples, and hybridization samples corresponding to the biological samples.

In some embodiments, a statistical model representing causal relationships among physical component(s) and/or workflow process(es) used to perform a sample processing workflow may include a graphical model. The graphical model may include nodes and directed edges. The nodes may represent random variables corresponding to some or all of the physical component(s) and/or some or all of the workflow process(es). The directed edges may represent causal relationships among physical components and/or workflow processes of the sample processing workflow.

A node corresponding to a physical component of the sample processing workflow may represent a random variable whose value is indicative of a degree to which the physical component contributes to error in data generated by processing biological samples in accordance with the sample processing workflow. Similarly, a node corresponding to a workflow process of the sample processing workflow represents a random variable whose value is indicative of a degree to which the workflow process contributes to error in the data generated by processing biological samples in accordance with the sample processing workflow. Identifying a source of error may involve determining an estimate of a posterior distribution of one or more of the random variables represented by the nodes in the graphical model given the values of one or more quality metrics. In some embodiments, determining the estimate is performed using a stochastic variational inference technique.

Some embodiments involve identifying attributes for physical component(s) and/or workflow process(es) of a sample processing workflow using the statistical models described herein. For example, an identified attribute for a physical component of the sample processing workflow may indicate whether the physical component is a source of error. As another example, an identified attribute for a physical component of the sample processing workflow may indicate whether the physical component needs service.

Some embodiments involve using the techniques described herein for monitoring attribute(s) of physical component(s) and/or workflow process(es) of a sample processing workflow over different groups of biological samples. The monitoring may allow for detecting a change in a physical component or a workflow process based on attribute(s) identified using the different groups of biological samples.

It should be appreciated that the statistical models described herein may be implemented in connection with a laboratory system, where physical components of the laboratory may be used to perform a specific sample processing workflow. Examples of physical component(s) that may be included in a system where a statistical model is used includes an extraction machine, an extraction automation system, a library preparation automation system, a thermocycler, an automation system, a sequencing machine, a hybridization machine, a centrifugation machine, a liquid handling system, and a qPCR machine. For example, a system for sequencing biological samples may include an extraction machine, a thermocycler, a sequencing machine, and a computing device configured to use a statistical model for identifying sources of error in the system. The statistical model may represent causal relationships among physical components of the system, including the extraction machine, the thermocycler, and the sequencing machine.

The technology described herein improves upon conventional techniques for diagnosing source of errors occurring in a sample processing workflow in a laboratory environment. In particular, the statistical models (e.g., graphical models, for example, Bayesian networks) described herein provide improvements over conventional methods for diagnosing sources of error in a sample processing workflow because these statistical models provide the ability to identify specific physical components, workflow processes, and/or biological samples as being source(s) of error rather than merely determining that a sample failed for some unknown reason, requiring someone to manually investigate aspects of the sample processing workflow separately to determine a source for the failure. Identifying more specific sources of error not only allows for these statistical models to accurately diagnose error sources, but reduces costs and time associated with operating the sample processing workflow and increases the number of biological samples that can be analyzed using the sample processing workflow (thereby increasing throughput of the laboratory). In addition, identifying a particular physical component (e.g., a piece of equipment, a reagent lot) of the sample processing workflow as being a source of error allows for further action to be taken that is specific to the identified physical component. This may involve fixing or repairing a piece of equipment, ordering a new lot of reagent, and notifying others that a piece of equipment or reagent lot should not be used. Furthermore, these statistical models described herein provide the ability to identify individual biological samples as being a source of error. This allows for distinguishing between when a biological sample is a source of error and a new biological sample is needed versus when some aspect of the sample processing workflow is the error source and needs to be evaluated.

To achieve the above-described level of specificity in identifying sources of error, data for multiple biological samples is used with a statistical model in order to generate sufficient statistics for identifying a source of error accurately. In some instances, data for multiple biological samples may be used to obtain values for quality metrics for each biological sample. For example, in some embodiments, there may be 500,000 biological samples and 14 different quality metrics. For each of the 500,000 biological samples a value for each of the 14 different quality metrics may be obtained, such that there are a total of 700,000 values for quality metrics. As the number of biological samples increases, the total number of values for quality metrics increases. For example, if there are 1,000,000 biological samples, then there are a total of 1,400,000 values for quality metrics. Given the number of quality metrics, the number of biological samples being processed and the size of the data generated from each of the biological samples (e.g., in a sequencing context, millions of sequence reads (each being 30-200 bases) may be generated for each of the biological samples) computing values for the quality metrics cannot be performed manually in any practical way and must be done using software. Moreover, the statistical inference techniques for inferring the posterior distribution of statistical model variables given input quality metric values (e.g., stochastic variational inference) cannot be performed manually in any practice way and must be done using software (e.g., special purpose optimization software).

Although the statistical models and computational techniques are described herein in connection with processing biological samples, it should be appreciated that they can be implemented in other environments where there are multiple physical components and workflow processes performing a processing workflow. For example, the techniques described herein may be implemented in manufacturing and chemical pipeline processes as well as biological sample processing. In such instances, a statistical model (e.g., a graphical model) may be used to represent causal relationships between physical component(s) and/or workflow process(es) that are used in the specific process and the types of quality metrics used in identifying source(s) of error may depend on those physical component(s) and/or workflow process(es).

It should be appreciated that the various aspects and embodiments described herein may be used individually, all together, or in any combination of two or more, as the technology described herein is not limited in this respect.

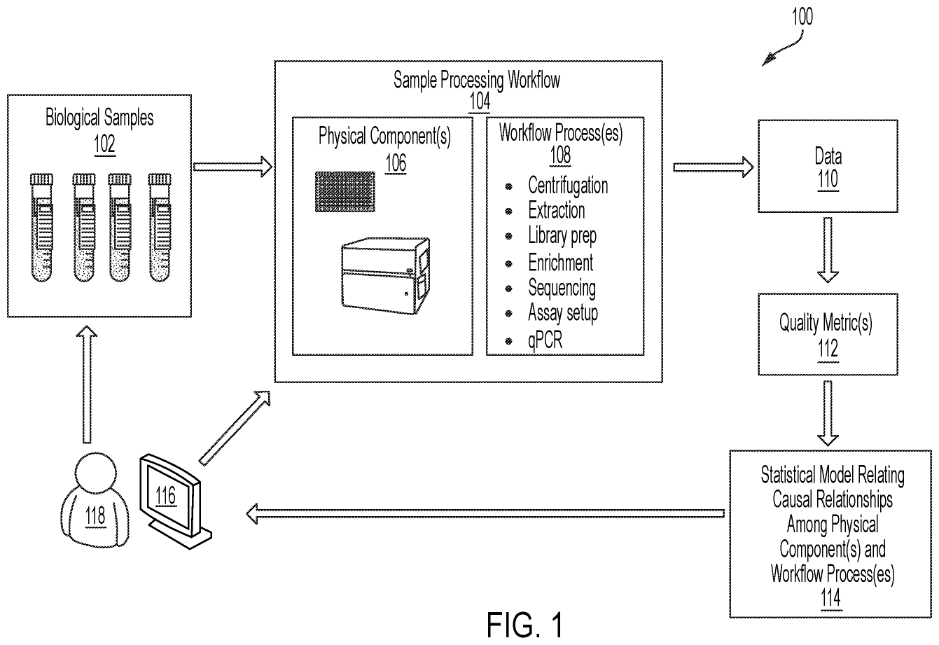

FIG. 1 is a diagram of an illustrative process 100 for identifying sources of error occurring during processing of biological samples in a laboratory environment using the computational techniques described herein. As shown in FIG. 1, biological samples 102 may be processed in accordance with sample processing workflow 104 to obtain data 110 about biological samples 102. For some or all of sample processing workflow 104, user 118 may be involved in processing biological samples 102. Sample processing workflow includes physical component(s) 106 (e.g., piece of equipment, reagent, sample plate) and workflow process(es) 108 (e.g., centrifugation, extraction, sequencing). Using data 110, value(s) for quality metric(s) 112 may be determined for some or all of biological samples 102. Process 100 includes statistical model 114 relating causal relationships among physical component(s) 106 and workflow process(es) 108. Using the value(s) for quality metric(s) 112 and statistical model 114, one or more sources of error for data 110 may be identified. Information indicative of the one or more sources of error may output to computing device 116, which may be presented to user 118.

Statistical model 114 represents causal relationships among physical component(s) 106 and/or workflow process(es) 108. The causal relationships represented by statistical model 114 may indicate which physical component(s) are used in performing one of workflow process(es) 108. The causal relationships represented by statistical model 114 may indicate how biological samples 102 are processed in accordance with sample processing workflow 104.

In some embodiments, workflow process(es) 108 include a sequencing process and physical component(s) 106 include one or more sequencing machines and one or more sequencing reagents. Statistical model 114 may represent causal relationships among the one or more sequencing machines, the one or more sequencing reagents, biological samples 102, and sequencing data generated by performing the sequencing process.

In some embodiments, workflow process(es) 108 include a hybridization process and physical component(s) 106 include one or more hybridization reagents and one or more hybridization machines. Statistical model 114 may represent causal relationships among the one or more hybridization reagents, the one or more hybridization machines, biological samples 102, and hybridization samples obtained by performing the hybridization process.

Biological samples 102 may include samples obtained from human subjects. Examples of biological samples include tissue, cell, biopsy, and nucleic acid samples from a subject. Additional examples of biological samples include saliva, sputum, hair, blood (e.g., whole blood), urine, stool, nasal swabs, throat swabs, buccal swabs, amniotic fluid, embryo biopsy, fetal tissue, placental tissue, cartilage, and bone. In some embodiments, biological samples 102 may include post-mortem samples obtained from deceased human subjects. In some embodiments, biological samples 102 may include biological molecules extracted from a sample obtained from a human subject. An example is cell-free DNA (cfDNA) extracted from a sample obtained from a subject, such as a blood sample.

In some embodiments, biological samples 102 may include nucleic acid samples obtained from one or more subjects. A nucleic acid sample may be provided in the form of a tissue or cell sample that is obtained from a subject and contains nucleic acids. In some embodiments, a nucleic acid sample may be a preparation of nucleic acids obtained from a tissue or cell sample. In some embodiments, the nucleic acid sample may be partially purified. In some embodiments, the nucleic acid sample may contain substantially purified nucleic acids.

In some embodiments, biological samples 102 may include at least 100 biological samples, 1,000 biological samples, 10,000 biological samples, or 100,000 biological samples. In some embodiments, biological samples 102 may include between 100-1,000 biological samples, 1,000-5,000 biological samples, between 5,000-10,000 biological samples, between 10,000-50,000 biological samples, between 50,000-100,000 biological samples, between 100,000-1,000,000 biological samples, between 1,000,000-10,000,000 biological samples, or any other range within these ranges.

Physical component(s) 106 may include pieces of equipment, automation systems, reagents, and other materials used in performing sample processing workflow 104. Examples of physical component(s) 106 include an extraction machine, an extraction automation system, a library preparation automation system, a thermocycler, an automation system, a sequencing machine, a hybridization machine, a centrifugation machine, a liquid handling system, and a qPCR machine. Examples of reagents include a buffer, a binding buffer, a wash buffer, an organic reagent, an inorganic reagent, an acidic solution, and a basic solution. Physical component(s) 106 may include disposable laboratory materials, including a sample plate, enrichment beads, a flow cell, a cartridge, a pipette, a pipette tip, and a sample tube. In some embodiments, physical component(s) 106 may include different types of mixes, including a bait mix, a hybridization mix, a sequencing mix, a PCR master mix, and a primer mix. Further examples of physical component(s) 106 include an enzyme and a labeled nucleotide.

In some embodiments, physical component(s) 106 may include a subsystem or particular part of a piece of equipment. For example, a thermocycler may be used in a sample processing workflow. The thermocycler itself may be considered as a physical component. Alternatively or in addition, a heat plate of the thermocycler may be considered as a physical component although it is a part of the thermocycler.

Workflow process(es) 108 may include different processing steps performed on biological samples 102 as part of sample processing workflow 104. Examples of workflow process(es) 108 include an extraction process, a library preparation process, an enrichment process, a hybridization process, a sequencing process, a centrifugation process, an assay setup process, an amplification process, and a qPCR process. According to some embodiments, one or more workflow processes may be performed in series to form the sample processing workflow. As an example, a sample processing workflow may both prepare a biological sample for sequencing and perform sequencing of the biological sample. The sample processing workflow may include an extraction process, followed by an enrichment process, followed by a sequencing process.

Workflow process(es) 108 may be performed using a combination of physical components. In some embodiments, sample processing workflow 104 includes a sequencing process as a workflow process and physical component(s) 106 may include one or more sequencing machines and one or more sequence reagents. In such embodiments, data 110 may include sequencing data for biological samples 102. In some embodiments, sample processing workflow 104 includes a hybridization process as a workflow process and physical component(s) 106 may include one or more hybridization reagents and one or more hybridization machines.

Data 110 may be generated by processing biological samples 102 in accordance with sample processing workflow 104. Data 110 may include data generated during performance of sample processing workflow 110. For example, sample processing workflow 104 may include multiple workflow processes and data 110 may include data generated during performance of one of the workflow processes. In some embodiments, data 110 may include data generated during completion of sample processing workflow 104.

Quality metric(s) 112 may include one or more quality metrics associated with sample processing workflow 104. For example, quality metric(s) 112 may include one or more metrics defined by analysis tools associated with a specific system, piece of equipment, or other physical component used in the sample processing platform. For example, the Picard metrics are a set of command line tools for analyzing high-throughput sequencing (HTS) data. Further details about Picard metrics may be found at <https://broadinstitute.github.io/picard/picard-metric-definitions.html>, which is incorporated herein by reference in its entirety.

Additionally or alternatively, as described herein, quality metric(s) 112 may include one or more quality metrics obtained from one or more applications downstream from the sample processing workflow such as alignment and/or variant calling, as described above. Additionally or alternatively, quality metric(s) 112 may include one or more quality metrics computed from measurements from one or more sensors. Examples of such sensors are provided herein.

In some embodiments, quality metric(s) 112 may include at least 3 quality metrics, at least 5 quality metrics, at least 10 quality metrics, at least 15 quality metrics, at least 20 quality metrics, or at least 30 quality metrics. In some embodiments, quality metric(s) 112 may include between 1-3 quality metrics, between 1-5 quality metrics, between 1-10 quality metrics, between 1-20 quality metrics, between 1-30 quality metrics, between 1-50 quality metrics, or between 10-100 quality metrics, or any other range within these ranges.

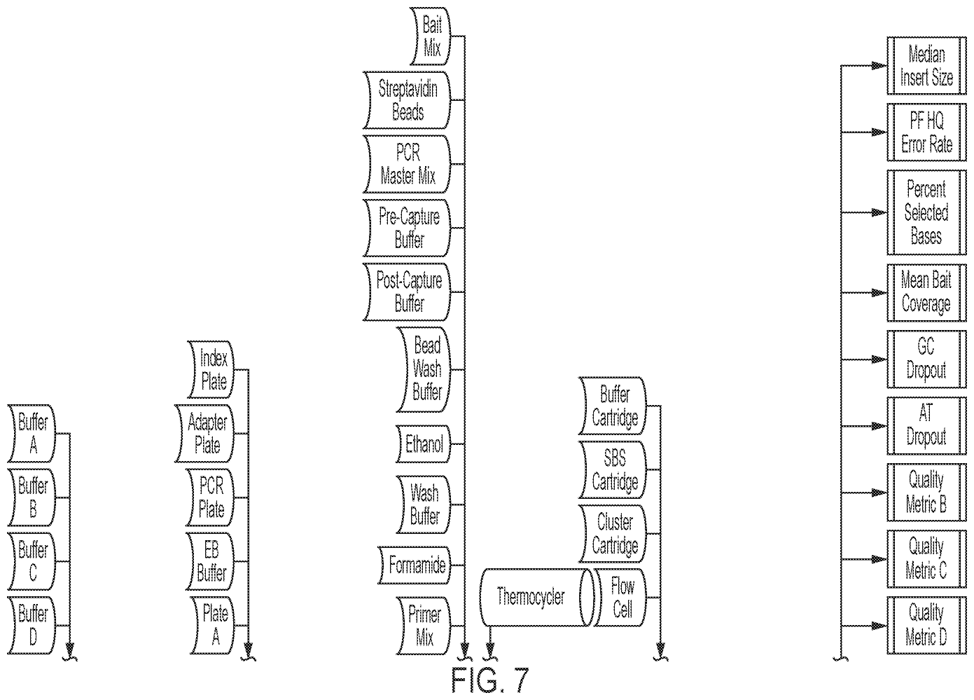

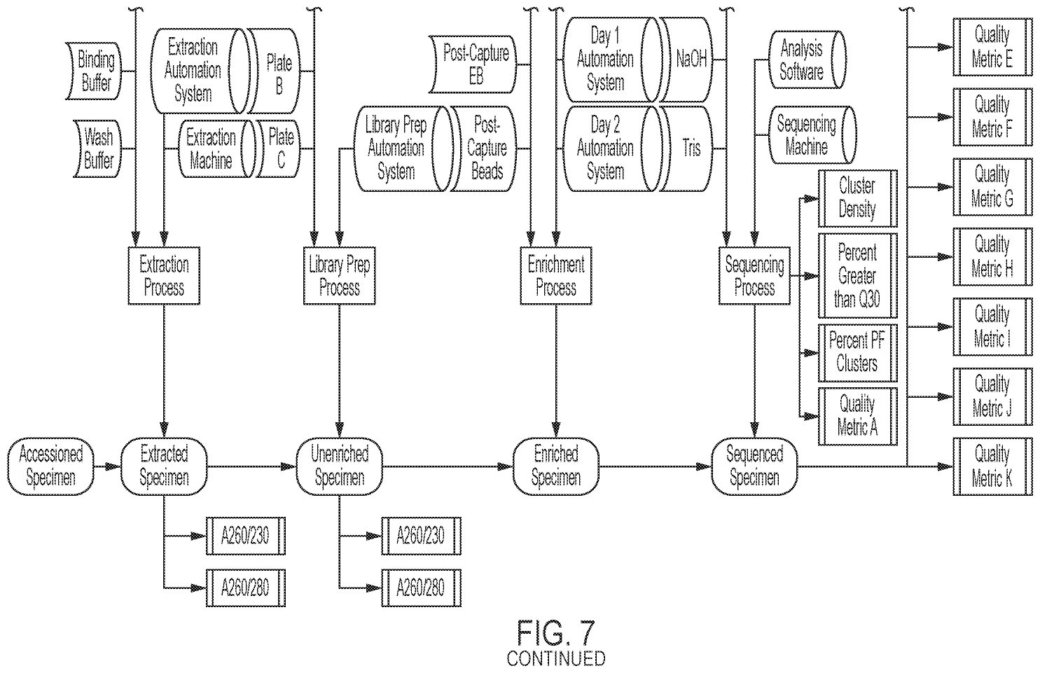

In some embodiments, a quality metric may be associated with a particular workflow process. As an example, one type of workflow process is a sequencing process. Quality metrics associated with the sequencing process may depend on the type of sequencing being performed. In the context of performing next-generation sequencing (NGS), quality metrics associated with a sequencing process include cluster density, percent greater than Q30, and percent PF clusters, such as shown in FIG. 7 which is described further below. Cluster density is a quality metric characterizing the number of clusters per unit area on a lane of a flow cell used for sequencing and is express in units of [cluster/mm²]. Cluster density is a quality metric used by some ILLUMINA™ sequencing machines and may be considered an ILLUMINA™ lane metric. Percent greater than Q30 is a quality metric characterizing the percentage of bases with a quality score of 30 or higher. Percent PF clusters is a quality metric characterizing the percentage of clusters passing filtering (PF). Further details about these quality metrics may be found at <https://broadinstitute.github.io/picard/picard-metric-definitions.html>, which is incorporated by reference in its entirety herein.

In some embodiments, a quality metric may be associated with results obtained by performing a workflow process. For example, performing a sequencing process may result in a sequenced sample and one or more quality metrics associated with the sequenced sample may be used in accordance with the techniques described herein. Quality metrics for a sequenced sample may include median insert size, passing filter (PF) high quality (HQ) error rate, percent selected bases, mean bait coverage, GC dropout, and AT dropout, such as shown in FIG. 7. Median insert size is a quality metric characterizing the median insert size of all paired end reads where both ends mapped to the same chromosome. PF HQ error rate is a quality metric characterizing the fraction of bases that mismatch the reference in the aligned reads that pass a defined filter and have high quality. Percent selected bases is a quality metric characterizing the fraction of aligned bases located on or near a baited region. Mean bait coverage is a quality metric characterizing mean coverage of all baits used. AT dropout is a quality metric characterizing how regions with low GC content (less than or equal to 50% GC) are undercovered relative to mean coverage. GC dropout is a quality metric characterizing how regions with high GC content (greater than or equal to 50% GC) are undercovered relative to mean coverage. Further details about these quality metrics may be found at <https://broadinstitute.github.io/picard/picard-metric-definitions.html>.

In addition, FIG. 7 shows quality metrics associated with the extracted specimen and the unenriched specimen. A₂₆₀/A₂₈₀ is a quality metric characterizing the ratio of absorbance of ultraviolet light at 260 nm and 280 for a sample and is an indicator of sample purity or whether a sample is considered to be “clean” and suitable for downstream applications. A₂₆₀/A₂₃₀ is a quality metric characterizing the ratio of absorbance of ultraviolet light at 260 nm and 230 for a sample and is another indicator of sample purity. Further details about these quality metrics may be found at <https://www.neb.com/-/media/nebus/files/application-notes/mvs_analysis_of_na_concentration_and_purity.pdf>, which is incorporated herein by reference in its entirety.

In some embodiments, a quality metric may be computed based on data gathered during an application downstream from sequencing. For example, a quality metric may be determined based on a confidence in the alignment of sequenced reads (obtained as part of a sequencing workflow) against a reference. The value of such a quality metric may be the confidence itself or any suitable function of the confidence. As another example, a quality metric may be computed based on the presence or absence of one or more expected variants. For example, the value of such quality metric may represent a percentage of expected-to-be-seen variants whose presence was detected in the sample (e.g., a very low percentage may indicate the presence of error in the sequencing workflow). In some embodiments, a quality metric may be computed based on measurements obtained by one or more sensors. Examples of such sensors are provided herein.

It should be appreciated that the quality metrics described herein are non-limiting and that other quality metrics may be used according to the techniques described herein, depending on the type of sample processing workflow being performed.

It should also be appreciated that not all the quality metrics described herein need to be used in a particular application, even if multiple quality metrics can be computed and their values might be available. For example, in a sample workflow process for sequencing, one or more intermediate quality metrics (e.g., one or more metrics computed after extraction is performed but before, for example, the A₂₆₀/A₂₈₀ metric described above) may be computed prior to the availability of sequencing metrics determined at the end of the sequencing process. Such intermediate metrics may be used together with or even without the downstream sequencing metrics. For example, the intermediate metrics, when indicating a problem, may be used to stop further performance of a sample processing workflow and avoid unnecessarily expending resources. For example, when extraction metrics indicate a problem with the underlying sample, the sequencing workflow may be stopped.

Quality metric(s) 112 may include multiple quality metrics and values of an aggregate metric computed using values for the multiple quality metrics may be used with statistical model 114 to identify one or more sources of error. In some embodiments, a value of the aggregate metric for a biological sample may be computed by calculating a product of the values of the multiple quality metrics determined for the biological sample. In some embodiments, calculating a product may involve calculating a product of values for different quality metrics associated with one of the biological samples 102. This is in contrast with averaging values for different quality metrics, which would typically be performed in other Bayesian networks. Here, aggregating values for different quality metrics by computing the product of the quality metrics and using the computed product with the statistical model may more accurately predict sources of error than if an averaged value for the quality metrics was used. This is in part because if a single quality metric for a biological sample indicates failure then results obtained by processing the biological sample are likely to have also been considered to fail or have poor quality. Additional ways of aggregating quality metric values are described herein. It should also be appreciated that the quality metrics may be grouped and the quality metric values in each group may be aggregated (using any of the ways described herein) to obtain a multi-dimensional aggregated value.

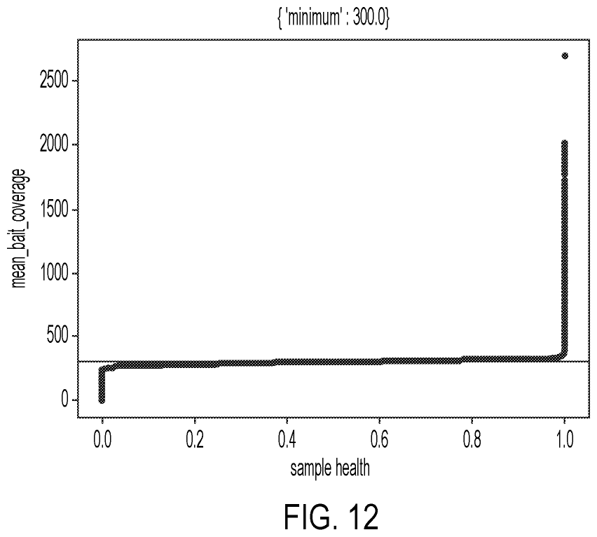

Some embodiments involve applying a logistic transformation to one or more of the values for quality metric(s) 112 and the transformed values may be used with statistical model 114 to identify source(s) of error occurring in sample processing workflow 104. In some embodiments, the transformed values may be aggregated by computing the product of the transformed values and using the computed product with the statistical model. The logistic transformation may involve converting values for a quality metric to be continuous values between 0 and 1, where a “1” indicates “pass” or “good” and a “0” indicates “fail” or “bad.” For example, if a value for mean bait coverage is less than 300, this may indicate that the failure for a sequenced sample. A logistic transformation for mean bait coverage may involve transforming values for mean bait coverage less than 300 to a value of “0” and values for mean bait coverage greater than or equal to 300 to a value of “1”. In embodiments that involve computing the product of transformed values for a particular biological sample, if any of the quality metrics has a transformed value of “0”, then the product is “0”, indicating failure of the sample processing workflow for the biological sample. FIG. 12 is a plot of mean bait coverage versus sample health and illustrates such a logistic transformation because values for mean bait coverage correspond to a value between 0 to 1 for sample health, with a “1” indicating a high sample health or a “pass” and a “0” indicating low sample health or a “fail.”

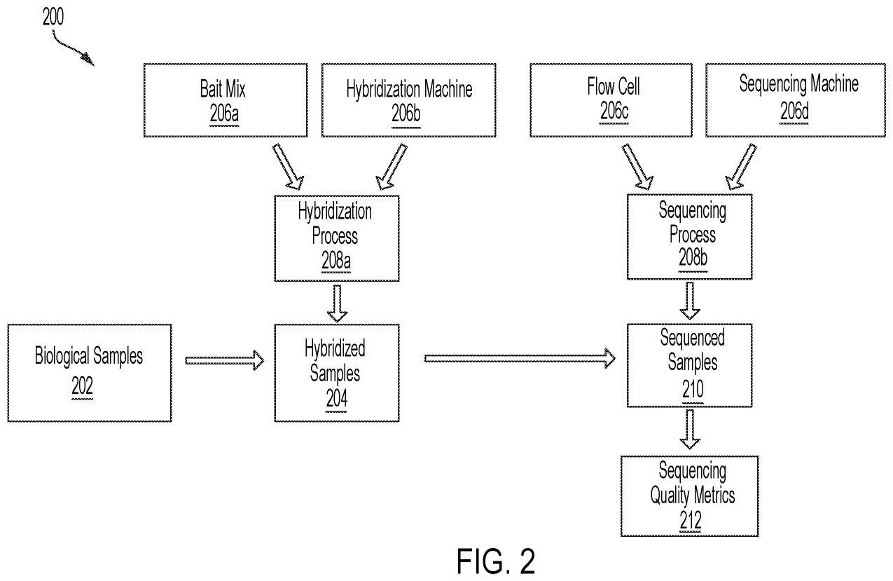

According to some embodiments, statistical model 114 includes a graphical model. The graphical model includes nodes representing random variables corresponding to one or more physical components and/or one or more workflow processes. Directed edges in the graphical model represent causal relationships among the one or more physical components and/or the one or more workflow processes. FIG. 2 is a schematic of graphical model 200 corresponding to a sample processing workflow that involves processing biological samples by performing: (1) a hybridization process using bait mix and hybridization machine(s); and (2) a sequencing process using flow cell(s) and sequencing machine(s). As shown in FIG. 2, graphical model 200 includes nodes for the physical components: bait mix 206a, hybridization machine 206b, and flow cell 206c. Graphical model 200 also includes nodes for the two workflow processes: hybridization process 208a and sequencing process 208b. Directed edges (indicated by arrows) represent casual relationships among these physical components and workflow processes. In particular, a bait mix and a hybridization machine are used in performing a hybridization process and graphical model 200 represents these causal relationships by including directed edges between bait mix 206a and hybridization process 208a as well as between hybridization machine 206b and hybridization process 208a. In addition, a flow cell and a sequencing machine are used in performing a sequencing process and graphical model 200 represents these causal relationships by including directed edges between flow cell 206c and sequencing process 208b and between sequencing machine 206d and sequencing process 208b.

In addition to physical components and workflow processes, graphical model 200 includes biological samples 202, a node representing biological samples that are processed by performing the hybridization process and the sequencing process. Graphical model 200 also includes hybridized samples 204 and sequenced samples 210, nodes representing results from performing the hybridization process and the sequencing process, respectively. Graphical model 200 also includes sequencing quality metrics 212, a node representing one or more quality metrics associated with the sequenced samples.

According to the techniques described herein, value(s) for quality metric(s) and a statistical model representing causal relationships among physical component(s) and/or workflow process(es) may be used to identify one or more sources of error in a sample processing workflow. In some embodiments, the statistical model includes a graphical model (e.g., a Bayesian network) and the nodes of the graphical model may represent random variables corresponding the physical component(s) and/or workflow process(es) of a sample processing workflow. A value for one of these random variables may indicate a degree to which what the node represents (e.g., a physical component, a workflow process) contributes to error in data generated by processing biological samples in accordance with the sample processing workflow.

Information other than quality metric(s) 112 may be used in identifying sources of error. In some embodiments, information indicative of an input from a user may be used in identifying one or more sources of error in a sample processing workflow. The information indicative of the input may be given a particular value for a variable associated with a node of the graphical model, and the value for the variable may be used in identifying sources of error. For example, a user may notice that a particular piece of equipment is not performing as expected. The user may provide an input indicating the piece of equipment as a possible source of error, and that input may be transformed into a value for a node in the graphical model associated with the piece of equipment.

In some embodiments, a random variable represented by a node in the graphical model may be a continuous-valued random variable (e.g., a Beta random variable, a Gaussian random variable, a random variable having a sigmoid distribution as described herein). In some embodiments, the random variable represented by a node (in the graphical model) may take on real values in the range [0 . . . 1], with the value indicating the likelihood that the physical component and/or workflow process represented by that node contributes to error. In this example, a value of 0 would indicate the likelihood that the physical component/workflow process contribute to error is 0%, or minimal, whereas a value of 1 would indicate that the likelihood that the physical component/workflow process contributes to error is 100%, significant/very likely. In other embodiments, the semantic meaning of the scale may be reversed with 0 indicating 100% contribution to error and 1 indicating 0% contribution to error, as aspects of the technology described herein. In other embodiments, different value ranges may be used to indicate the likelihood that the physical component and/or workflow process represented by that node contributes to error, as the present disclosure is not so limited.

Identifying one or more sources of error may involve identifying values for random variables represented by the nodes. In some embodiments, identifying a source of error may involve determining an estimate of a posterior distribution of one or more random variables represented by the nodes given values of one or more quality metrics. This may be performed using any suitable inference technique, as aspects of the technology described herein are not limited in this respect. For example, a stochastic variational inference technique may be used in determining the estimate. An example of a stochastic variational inference (SVI) technique is described in “Stochastic Variational Inference,” Matthew D. Hoffman, David M. Blei, Chong Wang, John Paisley; 14(4):1303-1347, 2013, which is incorporated herein by reference in its entirety. In some embodiments, the nodes may represent continuous-valued 0-1 random variables distributed in accordance with a Beta distribution. A logistic transformation may be applied to values of a quality metric for multiple biological samples. An output distribution of the logistic transformation may be used in determining values for the random variables in accordance with the Beta distribution.

In some embodiments, a posterior distribution for one or more random variables in a graphical model may be determined using the following components: prior distributions for one or more random variables in the graphical model (e.g., prior distributions for unobserved “root nodes” in the graphical model that do not have parent nodes), conditional distributions for one or more unobserved nodes in the graphical model (e.g., conditional distributions for unobserved nodes that have parent nodes in the graphical model), a likelihood function indicating the conditional density of one or more sequencing metrics given values of one or more unobserved nodes in the graphical model, and values of one or more quality metrics.

In some embodiments, the prior distribution for any “root node” in the graphical model may be a Beta distribution, with respective parameters α and β. Different root nodes may have the same parameters α and β or different parameters, as aspects of the technology described herein are not limited in this respect. However, it should be appreciated that the prior distribution for any “root node” may be any other suitable distribution supported on the unit interval, as aspects of the technology described herein are not limited in this respect.

In some embodiments, the conditional distribution for one or more unobserved nodes given its parents may be a Beta distribution. The parameters of this Beta distribution for a node may depend on the parameters of the Beta distributions associated with the parents nodes of the node in the graphical model. For example, in some embodiments, an unobserved child node in the graphical model may have multiple parent nodes (with respective parameters αᵢ and βᵢ) the parameters α and β of the Beta distribution for the child node may be set as follows:

$$α = {{\prod }_{i = 1}}^{n} {α}_{i}$$

$$β = 1 - α$$

In this way the child node is distributed according to Beta(α, β)=Beta(α, 1−α)=Beta(Πᵢ₌₁ⁿαᵢ, 1−Πᵢ₌₁ⁿαᵢ).

Now turning to the likelihood function, in some embodiments, a value for a quality metric (e.g., an individual quality metric or an aggregate quality metric) may be specified by modeling the distribution of the quality metric as a Gaussian distribution with mean μ and standard deviation, σ, as represented as follows:

quality metric˜N(μ, σ²)

However, since values of a quality metric may not be in the range of [0, 1] (the set of real numbers between 0 and 1, and inclusive of 0 and 1), a transformation may be employed to map the values of the quality metric to the interval [0, 1]. In some embodiments, such a transformation may be implemented using a logistic transformation. For example, in some embodiments, a value of an unobserved node in the graphical model (e.g., node “X”) may be related to the mean μ according to:

μ=logit(X; λ),

where λ is a scaling parameter.

When there are multiple quality metrics, values for the quality metrics may be aggregated for individual biological samples and the aggregate value may be used in the above equations. In some embodiments, the aggregate value is obtained by computing a product of the values for the quality metrics and the computed product may be used as the aggregate value. Additional ways of aggregating the quality metrics are described herein. One or more transformations may be used to map values for the quality metrics to the interval [0, 1]. In such embodiments, a logistic transformation may be employed to map the values for quality metrics to the interval [0, 1] and the aggregate value may be obtained by computing a product of the transformed values for the quality metrics.

Using the graphical model shown in FIG. 2 as an illustrative example of the above calculations, the nodes bait mix 206a, hybridization machine 206b, flow cell 206c, and sequencing machine 206d are root nodes. In addition, the nodes hybridization process 208a, hybridized samples 204, and sequencing process 208b are unobserved nodes having one or more parent nodes, where a conditional distribution for each of these nodes given its parent(s) may be set as follows:

$$child \sim Beta ( parent\_combo , 1 - parent\_combo ) ,$$

$$where parent\_combo = {\prod }_{i} {parent\_value}_{i}$$

Using these equations, the node hybridization process 208a may have a Beta distribution whose parameters depend on the parameters of the Beta distributions for the random variables represented by the bait mix 206a and hybridization machine 206b nodes. Similarly, the node sequencing process 208b may have a Beta distribution whose parameters depend on the parameters of the Beta distributions for the random variables represented by the flow cell 206c and sequencing machine 206d nodes. In addition, the node hybridized samples 204 may have a Beta distribution whose parameters depend on the parameters of the Beta distributions for the random variables represented by its parent nodes: biological samples 202 and hybridized samples 204. Sequenced samples 210 may have a Beta distribution whose parameters depend on the parameters of the Beta distributions for the random variables represented by the nodes sequencing process 208b and hybridized samples 204.

Since sequenced samples 210 connects to sequencing quality metrics 212, a value for sequenced samples 210 may be related to a meani.t for a distribution of quality metric values (e.g., an individual quality metric or an aggregate quality metric) according to:

μ=logit(sequenced sample; λ)

It should be appreciated that the above-described aspects of a statistical model used for identifying one or more sources of error are illustrative and that there are variations. For example, as described above, the distribution of a child node was defined as a Beta random variable parameterized by a parent combination value “parent_combo” (defined above, as a product of the values of the parent nodes, denoted as “parent_valueᵢ”). However, it should be appreciated that the distribution of a node conditioned on the values of its parent node(s) may be defined in other ways, including as described below.

Given a child node C in a graphical model, let us assume that the node C has P parent nodes, where P is an integer greater than or equal to one (so that the node has one or more parent nodes in the graphical model). Each of the P parent nodes takes on a value hᵢ in the unit interval. The value hᵢ may be indicative of a health score of the physical component or workflow process represented by the ith parent node. The health score indicates the likelihood that the physical component or workflow process represented by that node contributes to error.

In this context, the conditional distribution of the node C may be defined in two stages. First, the health scores of the parent nodes may be combined to form a combined parent health score “parent_combo”. Second, the “parent_combo” may be used to define the conditional distribution of the node C. Since that distribution will depend on the “parent_combo” value, it will be a distribution conditioned on the values of the parent nodes. Each of these two stages may be implemented in multiple ways, which may be mixed and matched with another as desired.

With respect to the first stage, there are multiple ways in which the combined parent score may be defined. As one example (which was also described above), in some embodiments, the combined parent score may be determined as a product of the individual parent scores according to:

$$parent\_combo = {{\prod }_{i}}^{P} {h}_{i}$$

As another example, in some embodiments, the combined parent score may be determined as a minimum of the individual parent scores according to:

parent_combo=min(h₀, . . . , h_{P})

As another example, in some embodiments, the combined parent score may be determined using a log-sum-exponential according to:

$$parent\_combo = \frac{1}{α} log ( \frac{1}{P} {\sum }_{i}^{P} exp ( α {h}_{i} ) )$$

In the above equation, the factor of 1/P is added to the usual log-sum-exponential to provide for normalization and α is set to any suitable value. The value of the parameter α may be set as a negative number far away from zero (e.g., −25, −50, −75, −100, etc.). The further away the value of α is from zero, the closer the resulting function is to approximating the minimum function (because in that case the value of the smallest hᵢ will contribute the most to the overall value of “parent_combo”). On the other hand, the closer the value of α is to 0, the more the other hᵢ values contribute to the overall value of “parent_combo”.

The inventors have appreciated that, in embodiments where it is desirable to have the combined parent score be determined as a minimum of the individual parent scores, one benefit to using the log-sum-exponential formulation to approximate the minimum value (rather than take the minimum value directly) is that the smoothness of the log-sum-exponential function facilitates using gradient optimization in the context of stochastic variational inference (SVI) when performing inference using the graphical model. Sharp cutoff non-linearities such as the minimum function may introduce numerical instabilities into the SVI methods.

After the combined parent score is determined in any of the ways described above (or in any other suitable way), that combined parent score may be used to define the conditional distribution of the child node. This may be done in any one of numerous ways.

As one example, in some embodiments (and as described in one foregoing example), the distribution may be defined as a Beta random variable according to:

h_{child}˜Beta(c·parent_combo, c·(1−parent_combo))

In this approach, the parameter c controls the degree to which the child distribution follows the parent combination value. The higher the value for c, the closer the child distribution follows the parent combination value (because the Beta distribution will be parameterized with a higher magnitude of hypercounts). On the other hand, when the parameter c takes on a value closer to 0, the child distribution follows the parent combination value much less closely. In some embodiments, the parameter c may be set to any suitable number between 0 and 100 (e.g., 0, 1, 2, 3, 4, 5, 6, 7, 8, 9, 10, 25, 50, 75, 100, or any other suitable integer or real number in that range).

As another example, in some embodiments, the distribution of a child node may be defined as a Normal random variable having a Gaussian distribution with its mean defined by parent_combo according to:

h_{child}˜ [symbol] (parent_combo, stdev)

The value of the standard deviation may be either fixed or learned as part of the model to provide confidence levels. In some embodiments, a truncated Normal distribution may be used instead of the usual Normal distribution so that the distribution is supported only on the unit interval

As another example, in some embodiments, the distribution of a child node may be defined using a sigmoid distribution obtained by normalizing the sigmoid function to the (0, 1) interval. This is defined as follows. Let the sigmoid function, parameterized by a slope and threshold parameters (s and t, respectively), be defined according to:

$$sigmoid ( x ; s , t ) = \frac{1}{1 + exp ( - s ( x - t ) )}$$

The slope parameter s is a positive value that defines the rate of change for the curve from 0 to 1 (representing, therefore, the “steepness” of the curve). Thus, the greater the value of s, the steeper the curve. The threshold parameter t defines which x-axis value corresponds to the y-axis value of 0.5 (i.e., the cross-over point).

The sigmoid distribution is then given by normalizing the sigmoid function as follows:

$$pdf ( x ; s , t ) = \frac{1}{Z} sigmoid ( x ; s , t )$$

$$\begin{matrix}Z = {\int }_{u}^{l} sigmoid ( x ; s , t ) \\ = 1 + \frac{1}{s} ln ( \frac{1 + exp ( - s ( u - t ) )}{1 + exp ( - s ( l - t ) )} )\end{matrix}$$

where (l, u)=(0, 1)

Given the foregoing definition, the distribution of a child node may be given according to:

h_{child}˜sigmoid(s, parent_combo)

Here, the child is distributed according to the sigmoid distribution (whose probability density function (pdf) is defined above), with its threshold parameter t being set to the combination parent value “parent_combo”, which may be determined in any of the ways described herein. The slope value s may be set to any suitable value and, for example, may be set to a value in the range of 10-100, 20-90, 30-80, or any other suitable range within these ranges.

Setting the threshold parameter to be the “parent_combo” value, means that the value of the child is distributed (approximately) equally between the “parent_combo” and 1. This may be useful for defining the distribution of metric nodes because a failing metric indicates a failing parent, but a passing metric does not necessarily indicate a passing parent. Put another way, a passing parent must emit a passing metric, but a failing parent can emit both passing and failing metrics.

As should be appreciated from the foregoing, the child distribution may be defined using any combination of technique of determining “parent_combo” value and distribution form. For example, the parent_combo value may be determined as a product, a min, or using soft-min approach via a log-sum-exponential and the distribution may be defined in terms of the “parent_combo” using a Beta distribution, a Normal distribution, or a sigmoid distribution. Thus, at least nine different types of ways of defining a child distribution conditioned on the health score(s) of its parents may be used.

Another aspect of the graphical models described herein is how the values of multiple quality metrics are incorporated into the graphical model as observations. In some embodiments, as described above, the values of multiple quality metrics are incorporated by aggregating their values to obtain a single aggregated value. The aggregation may be performed in any suitable way. For example, in some embodiments, the single aggregated value may be determined as a product of the quality metric values. As another example, in some embodiments, the single aggregated value may be determined as a minimum of the values of the quality metric values. As yet another example, in some embodiments, the single aggregated value may be determined as a soft-minimum of the values of the quality metric values using the log-sum-exponential approach described above.

Although, in some embodiments, the quality metric values may be aggregated to produce a single aggregated value, in other embodiments, the quality metric values may be aggregated into a multi-dimensional value, where each dimension contains a value obtained by aggregating the values of a group of one or more quality metrics. Different dimensions correspond to the different groups of metrics. For example, the quality metrics may be partitioned into K groups (e.g., K=2, 3, 4, 5, etc.) with each group having one or more quality metrics, and each group of quality metrics may be aggregated (using any of the ways described herein including, for example, product, minimum, or soft minimum) to determine a respective aggregate score—this generates K scores (one for each of the K groups) and so k-dimensional value is generated and this multi-dimensional value may be used as an observation to be incorporated into the graphical model.

The benefit of this multi-dimensional approach is that it provides more explainable results and facilitates discerning causes of error at a finer scale. For example, the quality metrics may be partitioned into two groups: a first group of one or more quality metrics related to measuring a degree of contamination of a sample and a second group containing the rest of the quality metrics. In this case, treating one or more contamination metrics separately provides the ability to determine whether detected errors in the laboratory workflow and/or problems with one or more physical laboratory components may be explained by sample or buffer contamination (as opposed to another cause) or, at the very least, to determine the degree to which any such contamination is impacting the overall performance of physical components and/or workflow processes. It should be noted, that when K=1, the multi-dimensional approach reduces to the single-aggregate-value approach in which all quality metric values are aggregated into a single aggregate value.

In yet other embodiments, the metrics may not be aggregated at all. In such embodiments, each sample instance may have a child metric node for each metric (e.g., M nodes if there are M metrics) and then use a sigmoid distribution to represent the metrics given the sample parent value. When a sigmoid distribution is used in this context to represent the conditional distribution of the child given the sample parent value, the overall approach will be similar to aggregating metrics by identifying or approximating (via soft-minimum) their minimum (e.g., the sample health score will be predicted at the minimum of the metric values).

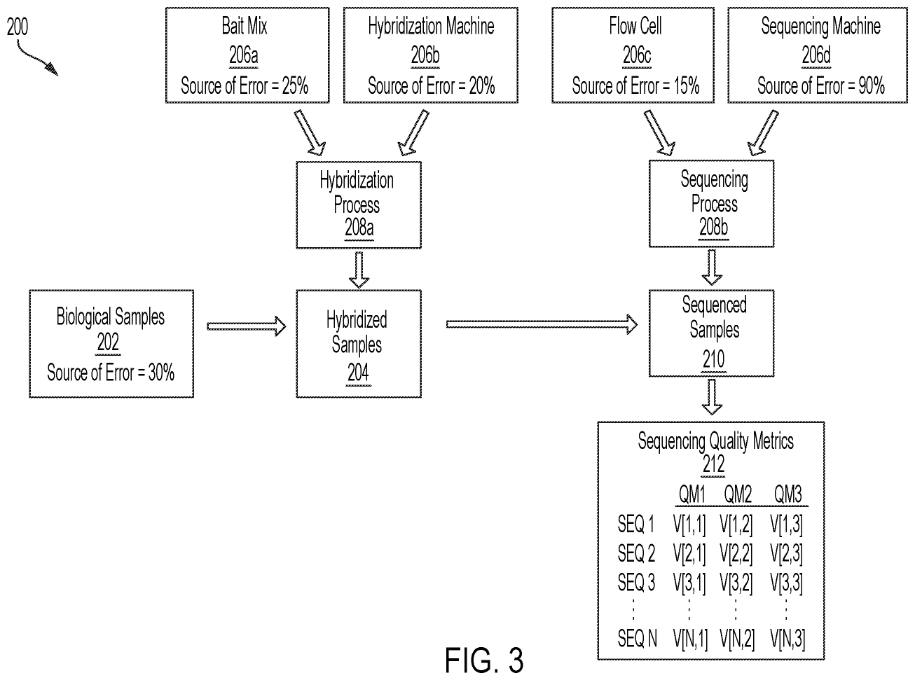

FIG. 3 shows example values for sequencing quality metrics 212 and source of error probabilities for biological samples 202, bait mix 206a, hybridization machine 206b, flow cell 206c, and sequencing machine 206d. In particular, sequencing quality metrics 212 include three different quality metrics (listed as QM1, QM2, and QM3), and values for these three quality metrics for different sequences (listed as SEQ 1, SEQ 2, SEQ 3 . . . SEQ N). For example, the values for QM1, QM2, and QM3 for SEQ 1 is V[1,1], V[1, 2], and V[1,3], respectively. Similarly, the values for QM1, QM2, and QM3 for SEQ 3 is V[3,1], V[3, 2], and V[3,3], respectively.

One or more sources of error may be identified using these values and graphical model 200. As shown in FIG. 3, the example source of error probabilities for biological samples 202, bait mix 206a, hybridization machine 206b, flow cell 206c, and sequencing machine 206d may be identified using graphical model 200 and values for sequencing quality metrics 212. The source of error probabilities for these nodes may correspond to values for random variables represented by these nodes estimated using the values for sequencing quality metrics 212. For example, biological samples 202 has a source of error equal to 30%, indicating that there is a 30% probability that the biological samples processed using sample processing workflow 200 is a source of error. As another example, hybridization machine 206b has a source of error equal to 20%, indicating that there is a 20% probability that the hybridization machine(s) used in performing the hybridization process is a source of error. As yet another example, sequencing machine 206d has a source of error equal to 90%, indicating that there is a 90% probability that sequencing machine(s) used in performing the sequencing process is a source of error. From the percentages for source of error for the different nodes of graphical model 200 shown in FIG. 3, and based on the different percentages for source of error for the different nodes of graphical model 200 shown in FIG. 3, the sequencing machine(s) used is the most likely source of error in the sequencing process.

In some embodiments, the graphical model may include separate nodes corresponding to different instances of the same type of information (e.g., same type of physical component, workflow process, biological sample) represented by the nodes. For example, three different sequencing machines may be implemented in performing a sample processing workflow and the graphical model may represent these sequencing machines as three different nodes. Such a graphical model may allow for identifying a particular sequencing machine as being a source of error. In some embodiments, the graphical model may include separate nodes corresponding to different biological samples connected to a common node. The common node may correspond to a common physical component or workflow process used to perform the sample processing workflow for the different biological samples.

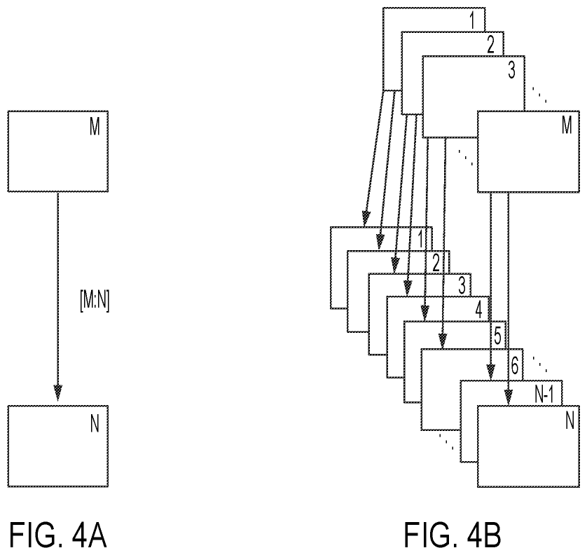

To assist in visualizing a graphical model that includes separate nodes for the same type of information, “plate notation” may be used. FIG. 4A is an example schematic illustrating how plate notation is used in visualizing a graphical model. In particular, FIG. 4A shows two nodes with a directed edge connecting the nodes. The source node is labeled with “M” in the upper right-hand corner, indicating that there are “M” separate nodes. Similarly, the sink node is labeled with “N” in the upper right-hand corner, indicating that there are “N” separate nodes. The directed edge is labeled with “[M:N]”, indicating that there are directed edges connecting between “M” number of nodes to “N” number of nodes.

FIG. 4B is a schematic illustrating the separate nodes corresponding to the plate notation used in FIG. 4A. As shown in FIG. 4B, each of the source nodes is connected to two separate sink nodes through a directed edge. For example, source node 1 connects to sink nodes 1 and 2. As another example, source node M connects to sink nodes N−1 and N. Although FIG. 4B shows there being fewer source nodes than sink nodes, it should be appreciated that plate notation may be used to indicate different ways of connecting any suitable number of source nodes to any suitable number of sink nodes.

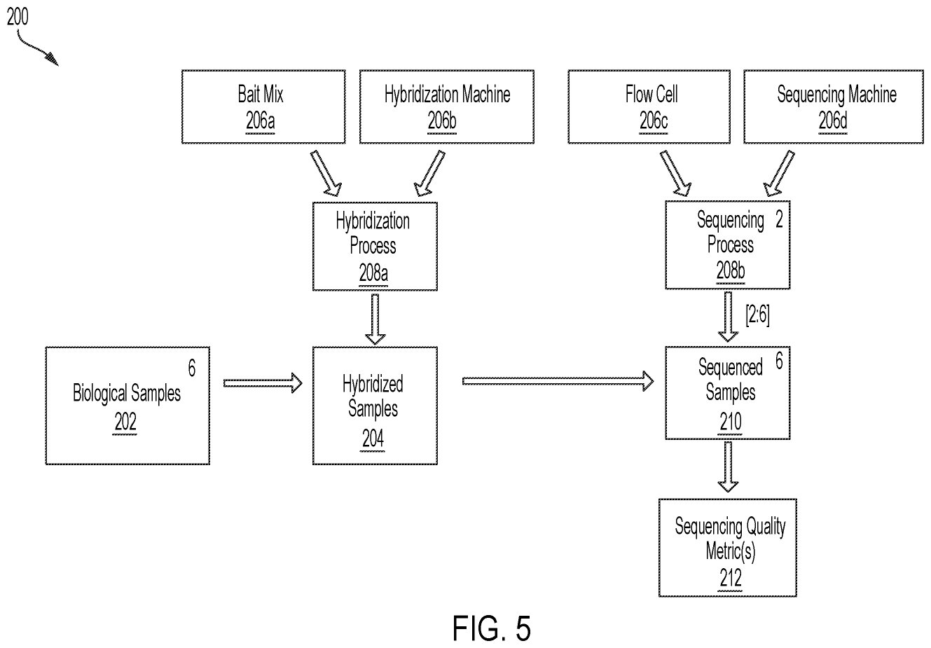

Returning to graphical model 200, plate notation may be used to indicate there are separate nodes for the different types of nodes illustrated in FIG. 2. FIG. 5 shows an example of using plate notation for graphical model 200. In particular, the node biological samples 202 has a “6” in the upper right-hand corner indicating that there are six separate nodes for different biological samples. The node for sequenced samples 210 also has a “6”, indicating that there are six separate nodes corresponding to the six nodes for the different biological samples. In addition, the node for sequencing process 208b has a “2” in the upper right-hand corner indicating that there are two separate nodes. The two separate nodes for a workflow process may indicate different instances of performing the workflow process, which may include different combinations of two or more physical components used in performing the workflow process. In the context of FIG. 5, the two separate nodes for sequencing process 208b may correspond to two separate sequencing runs used to sequence all of the biological samples. For each sequencing run, a particular flow cell in combination with a sequencing machine may be used. For example, different flow cells may be used for the two separate sequencing runs corresponding to the two separate nodes for sequencing process 208b. FIG. 5 also shows the label “[2:6]” for the edge connecting sequencing process 208b to sequenced samples 210.

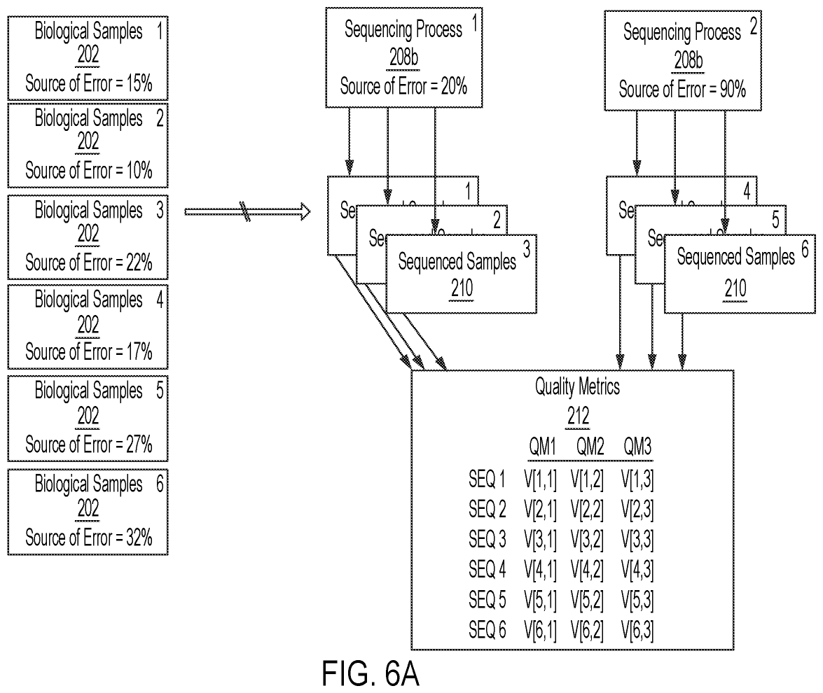

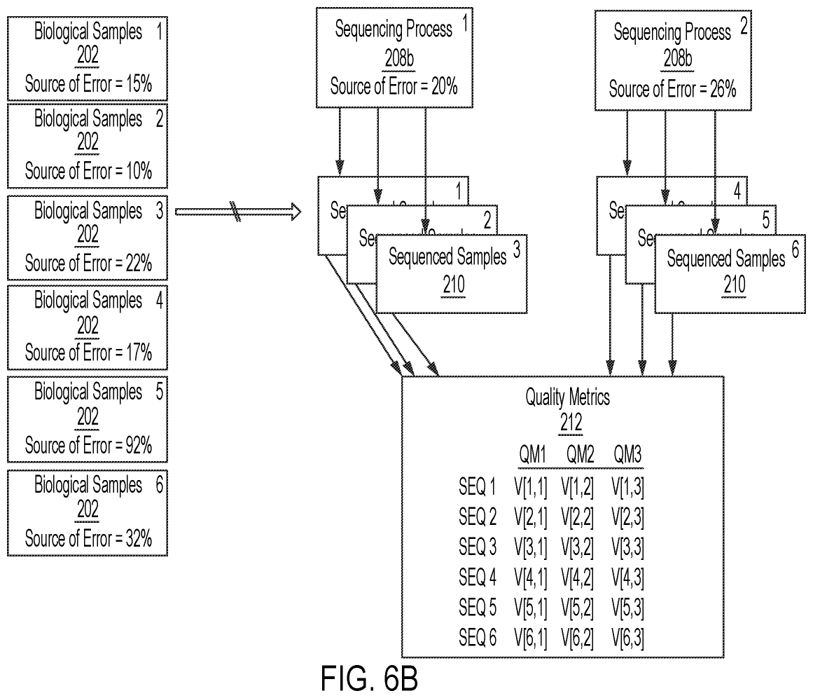

FIG. 6A shows example values for sequencing quality metrics 212 and source of error probabilities for the six nodes corresponding to biological samples 202 and the two nodes corresponding to sequencing process 208b. As shown in FIG. 6A, node 1 of sequencing process 208b is connects to nodes 1, 2, and 3 of sequenced samples 210, indicating that the same sequencing process is used for processing three biological samples corresponding to nodes 1, 2, and 3 of biological samples 202. In addition, node 2 of sequencing process 208b connects to nodes 4, 5, and 6 of sequenced samples 210, indicating that the same sequencing process is used for processing three biological samples corresponding to nodes 4, 5, and 6 of biological samples 202.

In this example, there are three quality metrics (QM1, QM2, QM 3) and values are obtained for each of six different sequences (SEQ 1, SEQ 2, SEQ 3, SEQ 4, SEQ 5, SEQ 6). These quality metric values and the graphical model shown in FIG. 5 are used to estimate the source of error probabilities shown in FIG. 6A. In particular, FIG. 6A shows how each of the biological samples has a corresponding source of error probability. Node 1 of biological samples 202 may correspond to a biological sample used to obtain SEQ 1 and has a source of error equal to 15%. Node 6 of biological samples 202 may correspond to a biological sample used to obtain SEQ 6 and has a source of error equal to 32%. In addition, FIG. 6A shows each of the two nodes of sequencing process 208b has a source of error probability. Node 1 of sequencing process 208b has a source of error equal to 20%. Node 2 of sequencing process 208b has a source of error equal to 90%.

From the different source of error probabilities, node 2 of sequencing process 208b is the most likely source of error. This information may indicate to a user that the biological samples associated with nodes 4, 5, and 6 of biological samples 202 are unlikely sources of error and may be processed again. This information may also suggest to a user that further evaluation of the sequencing process used for processing these biological samples may be needed. Although only source of error probabilities for the different nodes for biological samples 202 and sequencing process 208b are shown in FIG. 6A, it should be appreciated that source of error probabilities may be determined for other nodes of FIG. 2. For example, source of error probabilities may be obtained for nodes of flow cell 206c and nodes of sequencing machine 206d. These source of error probabilities may be used in evaluating the sequencing process corresponding to node 2 of sequencing process 208b to further assess whether a particular flow cell or sequencing machine used in performing the sequencing process is a source of error.

FIG. 6B shows a different example for source of error probabilities for the six nodes corresponding to biological samples 202 and the two nodes corresponding to sequencing process 208b. In this example, node 5 of biological samples 202 has a source of error equal to 92%, which is higher than the other source of error probabilities shown in FIG. 6B. This information may indicate to a user that the biological sample associated with node 5 of biological samples 202 as the source of error and that a new sample may be needed. This information may also indicate to a user that although biologicals samples corresponding to nodes 4, 5, and 6 were all processed using the same sequencing process, the sequencing process itself is unlikely a source of error and that the data obtained for the biological samples corresponding to nodes 4 and 6 may not be subject to error.

Although the above description is in the context of identifying source(s) of error in a sample processing workflow, it should be appreciated that the statistical models described herein may be used for other applications for assessing and evaluating a sample processing workflow. According to some embodiments, the statistical models described herein may be used for identifying attribute(s) for physical component(s) and/or workflow process(es) of a sample processing workflow. As described herein, a statistical model may include a graphical model with nodes representing random variables corresponding to physical component(s) and/or workflow process(es). A value for a random variable represented by a node may be indicative of a degree to which a physical component or a workflow process contributed to error in data generated by the sample processing workflow. Such a value for the random variable may be determined using the graphical model and value(s) of quality metric(s), as described herein.

These values for the random variables represented by nodes of the graphical model may allow for identifying attribute(s) for physical component(s) and/or workflow process(es) of a sample processing workflow. Identified attribute(s) may include an attribute for a physical component indicating whether the physical component is a source of error. In some embodiments, the identified attribute(s) includes an attribute for a physical component indicating whether the physical component needs service. For example, a value for a random variable representing a node corresponding to a piece of equipment may indicate a slightly higher probability that the piece of equipment contributed to error, but not high enough that the piece of equipment is a source of error (e.g., 60% source of error vs. 90% source of error). This slightly elevated value may indicate that the piece of equipment may need service before it becomes a source of error when processing future biological samples.

Some embodiments involve using the techniques described herein for monitoring attribute(s) of physical component(s) and/or workflow process(es) of a sample processing workflow over different groups of biological samples. The monitoring may allow for detecting a change in a physical component or a workflow process based on attribute(s) identified using the different groups of biological samples. The detected change may be output to a user, such as by displaying information indicative of the detected change in a physical component or a workflow process. In embodiments where the change is detected for a piece of equipment, a user may be notified that the piece of equipment needs repair. In embodiments where the change is detected for a lot number associated with a type of reagent, a user may be notified to discontinue use of reagents from the lot number.

In some embodiments, monitoring attribute(s) of physical component(s) and/or workflow process(es) of a sample processing workflow may involve obtaining first data about first biological samples, where the first data is generated by processing the first biological samples in accordance with the sample processing workflow. First value(s) of quality metric(s) for the first biological samples is determined. First attribute(s) for the physical component(s) and/or workflow process(es) may be identified using the first value(s) of the quality metric(s) and a statistical model. Similarly, second data about second biological samples may be obtained where the second data is generated by processing the second biological samples in accordance with the sample processing workflow. Second value(s) of the quality metric(s) for the second biological samples is determined, and second attribute(s) for the physical component(s) and/or workflow process(es) may be identified using the second value(s) of the quality metric(s) and the statistical model. A change in a physical component or a workflow process of the sample processing workflow may be detected based on the identified first attribute(s) and the identified second attribute(s). In some embodiments, the detected change indicates a physical component of the sample processing workflow needs service.

In some embodiments, the first biological samples are processed using the sample processing workflow during a first time period and the second biological samples are processed using the sample processing workflow during a second time period. In this manner, the physical component(s) and/or workflow process(es) of the sample processing workflow may be monitored over time.

FIG. 7 is a schematic of an example graphical model representing causal relationships for a next-generation sequencing (NGS) workflow. As shown in FIG. 7, the graphical model includes nodes for different physical components and workflow processes of the sequencing workflow. The workflow processes shown in FIG. 7 include an extraction process, a library preparation process, an enrichment process, and a sequencing process. It should be appreciated that some NGS sample processing workflows may not include all of these workflow processes shown in FIG. 7 (e.g., in some embodiments, sequencing may be performed without enrichment). In some embodiments, a NGS sample processing workflow may include one or more additional workflow processes. In some embodiments, a NGS sample processing workflow may include only some of the workflow processes shown in FIG. 7.

Physical components used in performing the extraction process include an extraction machine, an extraction automation system, and reagents, including buffers A, B, C, D, binding buffer, and wash buffer. An extracted specimen is an output of performing the extraction process. Quality metrics associated with the extracted specimen include A₂₆₀/A₂₃₀ and A₂₆₀/A₂₈₀.

Physical components used in performing the library preparation process include a library preparation automation system, an index plate, an adapter plate, a PCR plate, EB buffer, and other components, including plates A, B, and C. An unenriched specimen is an output of performing the library preparation process. Quality metrics associated with the unenriched specimen include A₂₆₀/A₂₃₀ and A₂₆₀/A₂₈₀.

Physical components used in performing the enrichment process include a thermocycler, day one automation system, day two automation system, bait mix, streptavidin beads, PCR master mix, pre-capture buffer, post-capture buffer, bead wash buffer, ethanol, wash buffer, formamide, primer mix, post-capture EB, and post-capture beads. An enriched specimen is an output of performing the enrichment process.

Physical components used in performing the sequencing process include a sequencing machine, analysis software, a buffer cartridge, SBS cartridge, cluster cartridge, flow cell, sodium hydroxide (NaOH), and tris(hydroxymethyl) aminomethane (Tris). A sequenced specimen is an output of the sequencing process. Quality metrics associated with the sequencing process include cluster density, percent greater than Q30, percent PF clusters, and quality metric A. Quality metrics associated with the sequenced specimen include median insert size, PF HQ error rate, percent selected bases, mean bait coverage, GC dropout, AT dropout, and quality metrics B, C, D, E, F, G, H, I, J, and K.

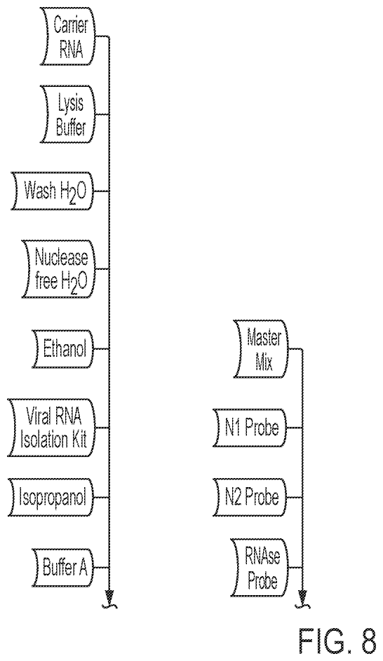

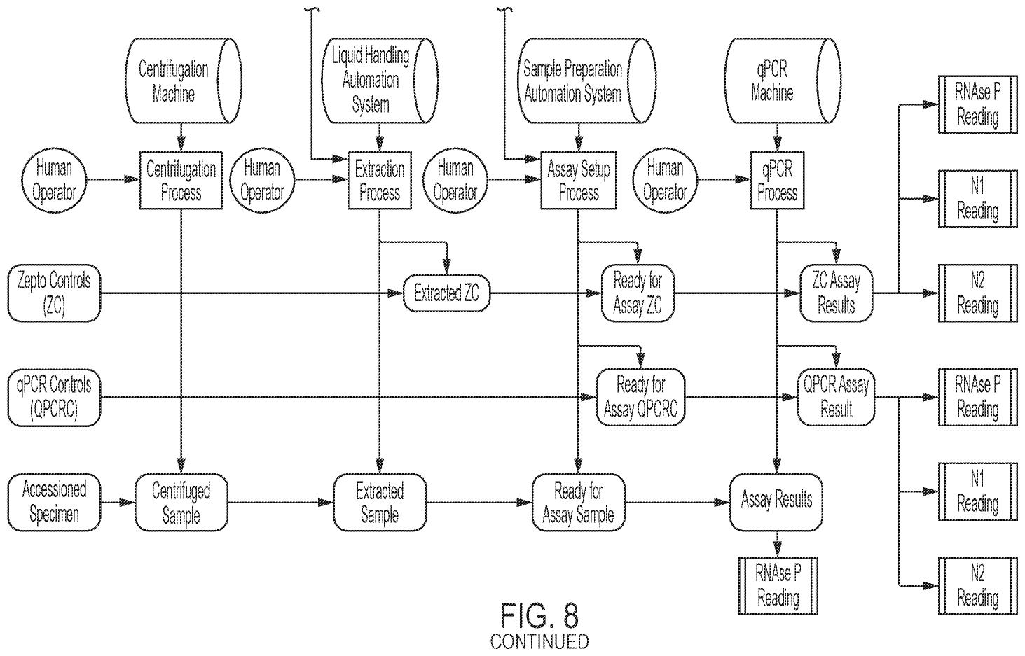

FIG. 8 is a schematic of an example graphical model representing causal relationships for a SARS-CoV-2 diagnostic testing workflow. The graphical model shown in FIG. 8 provides further examples as to types of information that can be representing in a graphical model according to the techniques described herein. For example, a graphical model may include a node representing a random variable corresponding to human operator, where a value of the random variable is indicative of a degree to which the human operator contributes to error. As another example, a graphical model may include nodes corresponding to control samples as well as outputs from performing one or more workflow processes for a control sample.

As shown in FIG. 8, the graphical model includes nodes for different physical components and workflow processes of the SARS-CoV-2 diagnostic testing workflow. The workflow processes include a centrifugation process, an extraction process, an assay setup process, and a qPCR process. One or more human operators may be involved each of these workflow processes. For example, a human operator may be involved in handling a biological sample, operating a piece of equipment, and preparing reagents. A centrifugation machine is used in performing the centrifugation process. A centrifuged sample is output from performing the centrifugation process.

Physical components used in performing the extraction process include a liquid handling automation system, and reagents, including carrier ribonucleic acid (RNA), lysis buffer, wash H₂O, nuclease free H₂O, ethanol, a viral RNA isolation kit, isopropanol, and buffer A. An extracted specimen is an output of performing the extraction process.

Physical components used in performing the assay setup process include a sample preparation automation system, master mix, N1 probe, N2 probe, and rNase probe. In this example, N1 and N2 are two gene targets. An output of the assay setup process is the sample being ready for a subsequent assay. A qPCR machine is used in performing the qPCR process. Assay results is an output of the qPCR process. A quality metric associated with the assay results is RNase P reading for the assay results.

The graphical model for the SARS-CoV-2 diagnostic testing workflow shown in FIG. 8 also includes nodes corresponding to zepto controls (ZC) and qPCR controls (QPCRC). In particular, an output of the extraction process is an extracted ZC. In addition, outputs of the assay setup process include is the ZC being ready for a subsequent assay and the QPCR being ready for a subsequent assay. Similarly, outputs of the qPCR process include ZC assay results and QPCR assay results. Quality metrics associated with both ZC assay results and QPCR assay results include rNase P reading, N1 reading, and N2 reading for the ZC assay results and the QPRCR assay results, respectively.

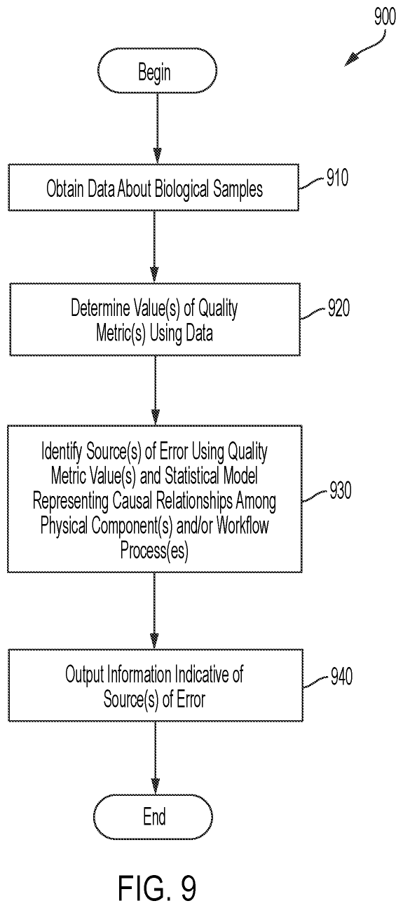

FIG. 9 is a flow chart of an illustrative process 900 for identifying sources of error occurring during processing of biological samples in a laboratory environment in accordance with a sample processing workflow, using some embodiments of the technology described herein. Process 900 may be performed on any suitable computing device(s) (e.g., a single computing device, multiple computing devices co-located in a single physical location or located in multiple physical locations remote from one another, one or more computing devices part of a cloud computing system, etc.), as aspects of the technology described herein are not limited in this respect. In some embodiments, statistical model 114 may be used to perform process 900 to identify sources of error.

Process 900 begins at act 910, where data about biological samples is obtained. The data may be generated by processing the biological samples in accordance with the sample processing workflow. In some embodiments, the data obtained at act 910 includes data generated during performance of the sample processing workflow. In some embodiments, the data obtained at act 910 includes data generated during completion of the sample processing workflow.

The sample processing workflow may be performed using physical component(s) and/or workflow process(es). The data obtained at act 910 may include data generated for one of the workflow process(es) performed as part of sample processing workflow.

The physical component(s) may include one or more reagents and/or one or more pieces of equipment used in the sample processing workflow. In some embodiments, the physical component(s) include one or more physical components selected from the group consisting of: an extraction machine, an extraction automation system, a library preparation automation system, a thermocycler, an automation system, a sequencing machine, a hybridization machine, a centrifugation machine, a liquid handling system, and a qPCR machine. In some embodiments, the physical component(s) include one or more reagents selected from the group consisting of: a buffer, a binding buffer, a wash buffer, an organic reagent, an inorganic reagent, an acidic solution, and a basic solution. In some embodiments, the physical component(s) include one or more selected from the group consisting of: a bait mix, a hybridization mix, a sequencing mix, a PCR master mix, and a primer mix. In some embodiments, the physical component(s) include one or more selected from the group consisting of: an enzyme, a labeled nucleotide, a sample plate, enrichment beads, a flow cell, a cartridge, a pipette, a pipette tip, and a sample tube.

The workflow process(es) may include one or more workflow processes selected from the group consisting of: an extraction process, a library preparation process, an enrichment process, a hybridization process, a sequencing process, a centrifugation process, an assay setup process, an amplification process, and a qPCR process.

A workflow process may be performed using a combination of physical components. In embodiments where the sample processing workflow includes a sequencing process as a workflow process, the physical component(s) may include one or more sequencing machines and one or more sequence reagents. The data obtained at act 910 may include sequencing data for each of some or all of the biological samples. In embodiments where the sample processing workflow includes a hybridization process as a workflow process, the physical component(s) may include one or more hybridization reagents and one or more hybridization machines.

Next, process 900 proceeds to act 920, where value(s) of quality metric(s) associated with the sample processing workflow are determined using the data obtained in act 910. Value(s) of quality metric(s) may be determined for some or all of the biological samples. Quality metrics may include one or more quality metrics associated with the sample processing workflow. In embodiments where the workflow process(es) includes a sequencing process, the quality metric(s) may include sequencing metrics for the sequencing data. In the context of performing next-generation sequencing (NGS), example quality metrics include cluster density, percent greater than Q30, and percent PF clusters, median insert size, passing filter (PF) high quality (HQ) error rate, percent selected bases, mean bait coverage, GC dropout, and AT dropout.

In some embodiments, quality metric(s) may include at least 3 quality metrics, at least 5 quality metrics, at least 10 quality metrics, at least 15 quality metrics, at least 20 quality metrics, or at least 30 quality metrics. In some embodiments, quality metric(s) may include between 1-3 quality metrics, between 1-5 quality metrics, between 1-10 quality metrics, between 1-20 quality metrics, between 1-30 quality metrics, between 1-50 quality metrics, or between 10-100 quality metrics, or any other range within these ranges.

Next process 900 proceeds to act 930, where source(s) of error are identified using the value(s) of quality metric(s) and a statistical model representing causal relationships among physical component(s) and/or workflow process(es), such as statistical model 114.

In embodiments where the workflow process(es) includes a sequencing process and the physical component(s) include one or more sequencing machines and one or more sequencing reagents, the statistical model may represent causal relationships among the one or more sequencing machines, the one or more sequencing reagents, the biological samples, and the sequencing data.

In embodiments where the workflow process(es) includes a hybridization process and the physical component(s) include one or more hybridization reagents and one or more hybridization machines, the statistical model may represent causal relationships among the one or more hybridization reagents, the one or more hybridization machines, the biological samples, and hybridization samples corresponding to the biological samples.

In some embodiments, the quality metric(s) include multiple quality metrics and act 930 is performed using the statistical model and values of an aggregate metric computed using values for the multiple quality metrics. In such embodiments, a value of the aggregate metric for a biological sample is computed by calculating a product of the values of the multiple quality metrics determined for the biological sample.

According to some embodiments, the statistical model includes a graphical model. The graphical model may include nodes representing random variables corresponding to some or all of the physical component(s) and/or the workflow process(es) and directed edges representing causal relationships among the physical component(s) and/or workflow process(es) represented by the nodes. A node corresponding to a physical component of the sample processing workflow may represent a random variable whose value is indicative of a degree to which the physical component contributes to error in the data generated by processing biological samples in accordance with the sample processing workflow. A node corresponding to a workflow process of the sample processing workflow may represent a random variable whose value is indicative of a degree to which the workflow process contributes to error in the data generated by processing biological samples in accordance with the sample processing workflow. In some embodiments, the graphical model includes a Bayesian network. In some embodiments, the nodes represent continuous-valued 0-1 random variables distributed in accordance with a Beta distribution.

According to some embodiments, identifying the source(s) of error at act 930 may include determining an estimate of a posterior distribution of one or more of the random variables represented by nodes in the graphical model given the value(s) of the quality metric(s). In some embodiments, determining the estimate is performed using a stochastic variational inference technique. An example of a stochastic variational inference technique is described in “Stochastic Variational Inference,” Matthew D. Hoffman, David M. Blei, Chong Wang, John Paisley; 14(4):1303-1347, 2013.

It should be appreciated that one or more variables of the posterior distribution may be used in identifying the source(s) of error. Some embodiments may involve determining value(s) for one or more variables of the posterior distribution and using those value(s) in identifying the source(s) of error. In some embodiments, value(s) for the mean, median, mode, variance, and/or standard deviation of the posterior distribution may be used in identifying the source(s) of error.

In some embodiments, the graphical model may include nodes representing observable random variables corresponding to results obtained by performing at least part of the sample processing workflow for the biological samples. A node of the graphical model may represent an observable random variable corresponding to results obtained by performing a workflow process of the sample processing workflow. For example, the graphical model may include a node representing a variable corresponding to sequence results obtained by performing a sequencing process.

Some embodiments involve using a graphical model that includes separate nodes corresponding to different biological samples connected to a common node. The common node may correspond to a common physical component or workflow process used to perform the sample processing workflow for the different biological samples. This may be visually represented using “plate notation” as described in connection with FIGS. 4A, 4B, 5, 6A, and 6B.

In some embodiments, a node of the graphical model corresponding to a workflow process performed as part of the sample processing workflow is connected to two or more of the physical components used in performing the workflow process. For example, FIG. 2 shows hybridization process 208a connected to bait mix 206a and hybridization machine 206b.

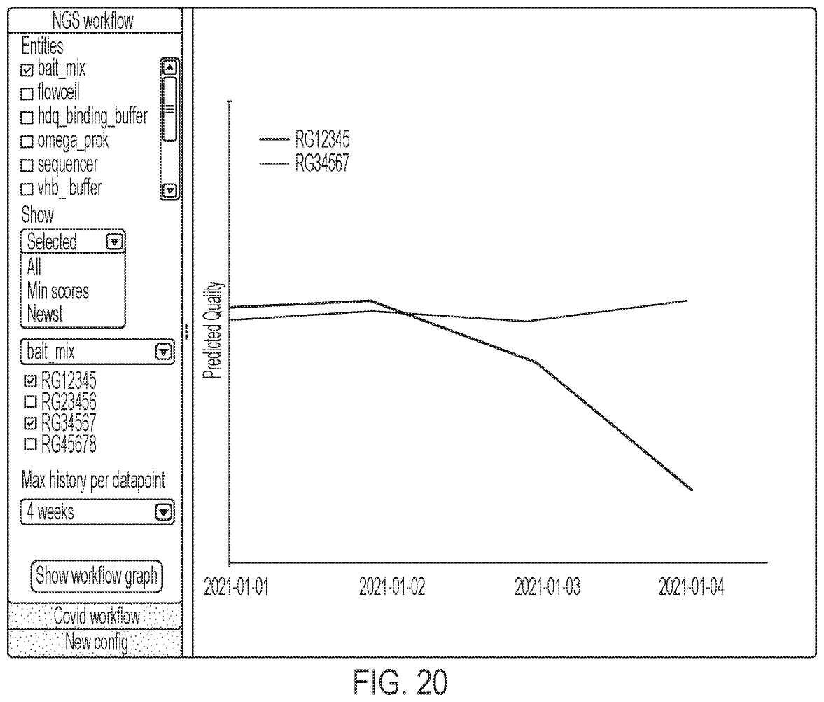

Next process 900 proceeds to act 940, where information indicative of the source(s) of error is output. In some embodiments, information indicative of the identified source(s) of error may be displayed to a user, such as via computing device 116 displaying a user interface (e.g., the user interface shown in FIG. 20).

Some embodiments involve identifying a physical component, from among the one or more physical components used to perform the sample processing workflow, as a source of error for the data generated by processing the biological samples. The information output at act 940 indicates the physical component as being a source of error. In some embodiments, the physical component may be a piece of equipment used to perform one or more workflow processes of the sample processing workflow. Information output at act 940 may include information identifying the piece of equipment. In some embodiments, the physical component may be a reagent from a lot used to perform one or more workflow processes of the sample processing workflow. Information output at act 940 may include information identifying the lot as a source of error for the data.

Some embodiments involve identifying a workflow process, from among the one or more workflow processes used to perform the sample processing workflow, as a source of error for the data generated by processing the biological samples.

Some embodiments involve identifying one or more of the biological samples as a source of error for the data generated by processing the biological samples.

In some embodiments, process 900 further includes an act of processing the biological samples in accordance with the sample processing workflow, such as via computing device 116.

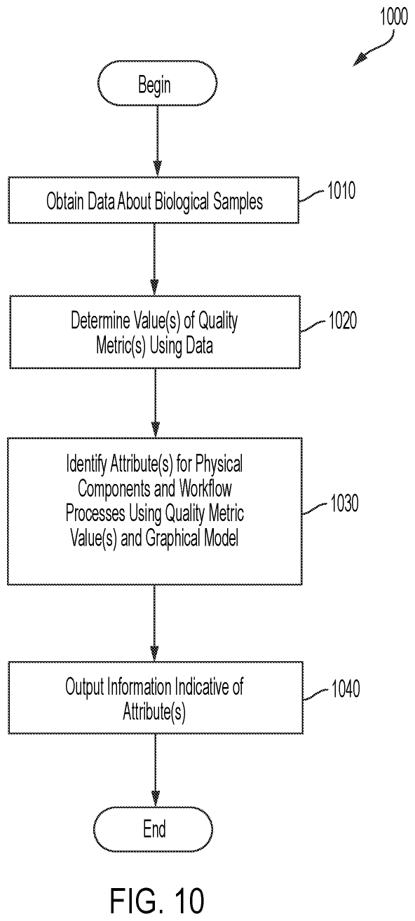

FIG. 10 is a flow chart of an illustrative process 1000 for identifying attribute(s) for physical component(s) and/or workflow process(es) of a sample processing workflow, in accordance with some embodiments of the technology described herein. Process 1000 may be performed on any suitable computing device(s) (e.g., a single computing device, multiple computing devices co-located in a single physical location or located in multiple physical locations remote from one another, one or more computing devices part of a cloud computing system, etc.), as aspects of the technology described herein are not limited in this respect. In some embodiments, statistical model 114 may be used to perform process 1000 to identify the attribute(s).

Process 1000 begins at act 1010, where data about biological samples is obtained. The data may be generated by processing the biological samples in accordance with the sample processing workflow. The sample processing workflow may be performed using the physical component(s) and workflow process(es).

The physical component(s) may include one or more reagents and/or one or more pieces of equipment used in the sample processing workflow. In some embodiments, the physical component(s) include one or more physical components selected from the group consisting of: an extraction machine, an extraction automation system, a library preparation automation system, a thermocycler, an automation system, a sequencing machine, a hybridization machine, a centrifugation machine, a liquid handling system, and a qPCR machine. In some embodiments, the physical component(s) include one or more reagents selected from the group consisting of: a buffer, a binding buffer, a wash buffer, an organic reagent, an inorganic reagent, an acidic solution, and a basic solution. In some embodiments, the physical component(s) include one or more selected from the group consisting of: a bait mix, a hybridization mix, a sequencing mix, a PCR master mix, and a primer mix. In some embodiments, the physical component(s) include one or more selected from the group consisting of: an enzyme, a labeled nucleotide, a sample plate, enrichment beads, a flow cell, a cartridge, a pipette, a pipette tip, and a sample tube.

The workflow process(es) may include one or more workflow processes selected from the group consisting of: an extraction process, a library preparation process, an enrichment process, a hybridization process, a sequencing process, a centrifugation process, an assay setup process, an amplification process, and a qPCR process.

A workflow process may be performed using a combination of physical components. In embodiments where the sample processing workflow includes a sequencing process as a workflow process, the physical component(s) may include one or more sequencing machines and one or more sequence reagents.

Next, process 1000 proceeds to act 1020, where value(s) of quality metric(s) associated with the sample processing workflow may be determined using the data obtained in act 1010. The value(s) of the quality metric(s) may be determined for each of one or more of the biological samples. Quality metrics may include one or more quality metrics associated with the sample processing workflow. In embodiments where the workflow process(es) includes a sequencing process, the quality metric(s) may include sequencing metrics for the sequencing data. In the context of performing next-generation sequencing (NGS), example quality metrics include cluster density, percent greater than Q30, and percent PF clusters, median insert size, passing filter (PF) high quality (HQ) error rate, percent selected bases, mean bait coverage, GC dropout, and AT dropout.

In some embodiments, quality metric(s) may include at least 3 quality metrics, at least 5 quality metrics, at least 10 quality metrics, at least 15 quality metrics, at least 20 quality metrics, or at least 30 quality metrics. In some embodiments, quality metric(s) may include between 1-3 quality metrics, between 1-5 quality metrics, between 1-10 quality metrics, between 1-20 quality metrics, between 1-30 quality metrics, between 1-50 quality metrics, or between 10-100 quality metrics, or any other range within these ranges.

Next, process 1000 proceeds to act 1030, where attribute(s) for the physical component(s) and/or workflow process(es) may be identified. The identifying may be performed using the value(s) of the quality metric(s) and a graphical model comprising nodes representing random variables corresponding to the physical component(s) and/or the workflow process(es). Each of one or more of the nodes may represent a random variable whose value is indicative of a degree to which a physical component or a workflow process contributed to error in the data generated by processing the plurality of biological samples in accordance with the sample processing workflow. In some embodiments, the graphical model includes a Bayesian network.

According to some embodiments, identifying the attribute(s) at act 1030 may include determining an estimate of a posterior distribution of one or more of the random variables represented by nodes in the graphical model given the value(s) of the quality metric(s). In some embodiments, determining the estimate is performed using a stochastic variational inference technique. An example of a stochastic variational inference technique is described in “Stochastic Variational Inference,” Matthew D. Hoffman, David M. Blei, Chong Wang, John Paisley; 14(4):1303-1347, 2013.

It should be appreciated that one or more variables of the posterior distribution may be used in identifying the attribute(s). Some embodiments may involve determining value(s) for one or more variables of the posterior distribution and using those value(s) in identifying the attribute(s). In some embodiments, value(s) for the mean, median, mode, variance, and/or standard deviation of the posterior distribution may be used in identifying the attribute(s).

In some embodiments, the quality metric(s) include multiple quality metrics and act 1030 is performed using the statistical model and values of an aggregate metric computed using values for the multiple quality metrics. In such embodiments, a value of the aggregate metric for a biological sample is computed by calculating a product of the values of the multiple quality metrics determined for the biological sample.

In some embodiments, the identified attribute(s) includes an attribute for a physical component indicating whether the physical component is a source of error. In some embodiments, the identified attribute(s) includes an attribute for a physical component indicating whether the physical component needs service.

In some embodiments, the graphical model includes nodes representing observable random variables corresponding to results obtained by performing at least part of the sample processing workflow for the biological samples. The graphical model may include a node corresponding to results obtained by performing a workflow process. For example, the graphical model may include a node for a sequenced sample obtained by performing a sequencing process.

In some embodiments, the graphical model may include separate nodes corresponding to different biological samples connected to a common node corresponding to a common physical component or workflow process used to perform the sample processing workflow for the different biological samples. This may be visually represented using “plate notation” as described in connection with FIGS. 4A, 4B, 5, 6A, and 6B.

In some embodiments, the graphical model may include a node corresponding to a workflow process performed as part of the sample processing workflow connects to two or more of the physical component(s) used in performing the workflow process. For example, FIG. 2 shows hybridization process 208a connected to bait mix 206a and hybridization machine 206b.

Next process 1000 proceeds to act 1040, where information indicative of the identified attribute(s) is output. In some embodiments, information indicative of the identified attribute(s) may be displayed to a user, such as via computing device 116 displaying a user interface (e.g., the user interface shown in FIG. 20).

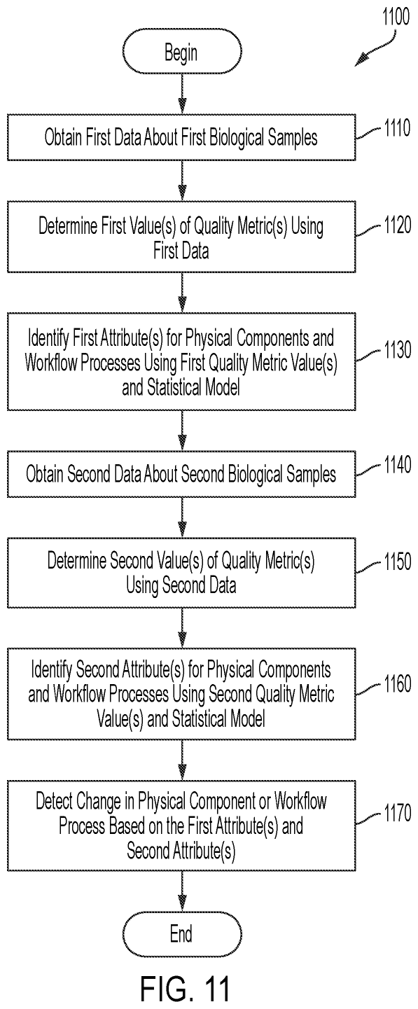

FIG. 11 is a flow chart of an illustrative process 1100 for monitoring attributes of physical component(s) and/or workflow process(es) used in performing a sample processing workflow, in accordance with some embodiments of the technology described herein. Process 1100 may be performed on any suitable computing device(s) (e.g., a single computing device, multiple computing devices co-located in a single physical location or located in multiple physical locations remote from one another, one or more computing devices part of a cloud computing system, etc.), as aspects of the technology described herein are not limited in this respect. In some embodiments, statistical model 114 may be used in performing process 1100 to monitor attributes of physical component(s) and/or workflow process(es).

Process 1100 begins at act 1110, where first data about first biological samples is obtained. The first data may be generated by processing the first biological samples in accordance with the sample processing workflow. The sample processing workflow may be associated with quality metric(s).

The physical component(s) may include one or more reagents and/or one or more pieces of equipment used in the sample processing workflow. In some embodiments, the physical component(s) include one or more physical components selected from the group consisting of: an extraction machine, an extraction automation system, a library preparation automation system, a thermocycler, an automation system, a sequencing machine, a hybridization machine, a centrifugation machine, a liquid handling system, and a qPCR machine. In some embodiments, the physical component(s) include one or more reagents selected from the group consisting of: a buffer, a binding buffer, a wash buffer, an organic reagent, an inorganic reagent, an acidic solution, and a basic solution. In some embodiments, the physical component(s) include one or more selected from the group consisting of: a bait mix, a hybridization mix, a sequencing mix, a PCR master mix, and a primer mix. In some embodiments, the physical component(s) include one or more selected from the group consisting of: an enzyme, a labeled nucleotide, a sample plate, enrichment beads, a flow cell, a cartridge, a pipette, a pipette tip, and a sample tube.

The workflow process(es) may include one or more workflow processes selected from the group consisting of: an extraction process, a library preparation process, an enrichment process, a hybridization process, a sequencing process, a centrifugation process, an assay setup process, an amplification process, and a qPCR process.

A workflow process may be performed using a combination of physical components. In embodiments where the sample processing workflow includes a sequencing process as a workflow process, the physical component(s) may include one or more sequencing machines and one or more sequence reagents.

Next, process 1100 proceeds to act 1120, where first value(s) of the quality metric(s) for each of some or all of the first biological samples is determined using the first data obtained in act 1110. Quality metrics may include one or more quality metrics associated with the sample processing workflow. In embodiments where the workflow process(es) includes a sequencing process, the quality metric(s) may include sequencing metrics for the sequencing data. In the context of performing next-generation sequencing (NGS), example quality metrics include cluster density, percent greater than Q30, and percent PF clusters, median insert size, passing filter (PF) high quality (HQ) error rate, percent selected bases, mean bait coverage, GC dropout, and AT dropout.

In some embodiments, quality metric(s) may include at least 3 quality metrics, at least 5 quality metrics, at least 10 quality metrics, at least 15 quality metrics, at least 20 quality metrics, or at least 30 quality metrics. In some embodiments, quality metric(s) may include between 1-3 quality metrics, between 1-5 quality metrics, between 1-10 quality metrics, between 1-20 quality metrics, between 1-30 quality metrics, between 1-50 quality metrics, or between 10-100 quality metrics, or any other range within these ranges.

Next, process 1100 proceeds to act 1130, where first attribute(s) for the physical component(s) and/or workflow process(es) may be identified using the first value(s) of the quality metric(s) and a statistical model. In some embodiments, the statistical model represents causal relationships among the physical component(s) and/or the workflow process(es) used to perform the sample processing workflow.

In some embodiments, the quality metric(s) include multiple quality metrics and act 1130 is performed using the statistical model and values of an aggregate metric computed using the first values for the multiple quality metrics. In such embodiments, a value of the aggregate metric for a biological sample is computed by calculating a product of the first values of the multiple quality metrics determined for the biological sample.

According to some embodiments, the statistical model includes a graphical model. The graphical model may include nodes representing random variables corresponding to some or all of the physical component(s) and/or the workflow process(es) and directed edges representing causal relationships among the physical component(s) and/or workflow process(es) represented by the nodes. A node corresponding to a physical component of the sample processing workflow may represent a random variable whose value is indicative of a degree to which the physical component contributes to error in the data generated by processing biological samples in accordance with the sample processing workflow. A node corresponding to a workflow process of the sample processing workflow may represent a random variable whose value is indicative of a degree to which the workflow process contributes to error in the data generated by processing biological samples in accordance with the sample processing workflow. In some embodiments, the graphical model includes a Bayesian network. In some embodiments, the nodes represent continuous-valued 0-1 random variables distributed in accordance with a Beta distribution.

According to some embodiments, identifying the first attribute(s) at act 1130 may include determining an estimate of a posterior distribution of one or more of the random variables represented by nodes in the graphical model given the value(s) of the quality metric(s). In some embodiments, determining the estimate is performed using a stochastic variational inference technique. An example of a stochastic variational inference technique is described in “Stochastic Variational Inference,” Matthew D. Hoffman, David M. Blei, Chong Wang, John Paisley; 14(4):1303-1347, 2013.

Some embodiments may involve determining value(s) for one or more variables of the posterior distribution and using those value(s) in identifying the first attribute(s). In some embodiments, value(s) for the mean, median, mode, variance, and/or standard deviation of the posterior distribution may be used in identifying the first attribute(s).

Next, process 1100 proceeds to act 1140, where second data about second biological samples is obtained. The second data may be generated by processing the second biological samples in accordance with the sample processing workflow.

In some embodiments, the first biological samples are processed using the sample processing workflow during a first time period and the second biological samples are processed using the sample processing workflow during a second time period. In this manner, the physical component(s) and/or workflow process(es) of the sample processing workflow may be monitored over time.

Next, process 1100, proceeds to act 1150, where second value(s) of the quality metric(s) for each of some or all of the second biological samples is determined using the second data obtained in act 1140.

Next, process 1100, proceeds to act 1160, where second attribute(s) for the physical component(s) and/or workflow process(es) may be identified using the second value(s) of the quality metric(s) and the statistical model. Some embodiments may involve determining value(s) for one or more variables of the posterior distribution and using those value(s) in identifying the second attribute(s). In some embodiments, value(s) for the mean, median, mode, variance, and/or standard deviation of the posterior distribution may be used in identifying the second attribute(s).

In some embodiments, the quality metric(s) include multiple quality metrics and act 1160 is performed using the statistical model and values of an aggregate metric computed using the second values for the multiple quality metrics. In such embodiments, a value of the aggregate metric for a biological sample is computed by calculating a product of the second values of the multiple quality metrics determined for the biological sample.

Next process 1100 proceeds to act 1170, a change in a physical component or a workflow process of the sample processing workflow is detected based on the identified first attribute(s) and the identified second attribute(s). In some embodiments, the detected change indicates a physical component of the sample processing workflow needs service.

In some embodiments, process 1100 further includes outputting information indicative of the change in the physical component or the workflow process. The information indicative of the change in the physical component or the workflow process may be displayed to a user, such as via computing device 116 displaying a user interface (e.g., the user interface shown in FIG. 20).

Some embodiments may involve outputting information indicative of a change in a physical component or a workflow process if the change meets certain criteria. If the detected change does not meet the criteria, then the change may be considered not significant enough to warrant action and not outputted. In some embodiments, process 1100 may involve comparing the change in a physical component or a workflow process of the sample processing workflow to a threshold value (e.g., a minimum value). If the detected change is equal to or above the threshold value, then process 1100 may involve outputting information indicative of the change. However, if the detected change is below the threshold value, then process 1100 may involve determining that the change is not significant. In such instances, the change may not be outputted to a user.

Suitable action may be taken once a change is detected at act 1170. In embodiments where the change is detected for a piece of equipment, process 1100 may further include notifying a user a piece of equipment needs repair. In embodiments where the change is detected for a lot number associated with a type of reagent, process 1100 may further include notifying a user to discontinue use of reagents from the lot number.

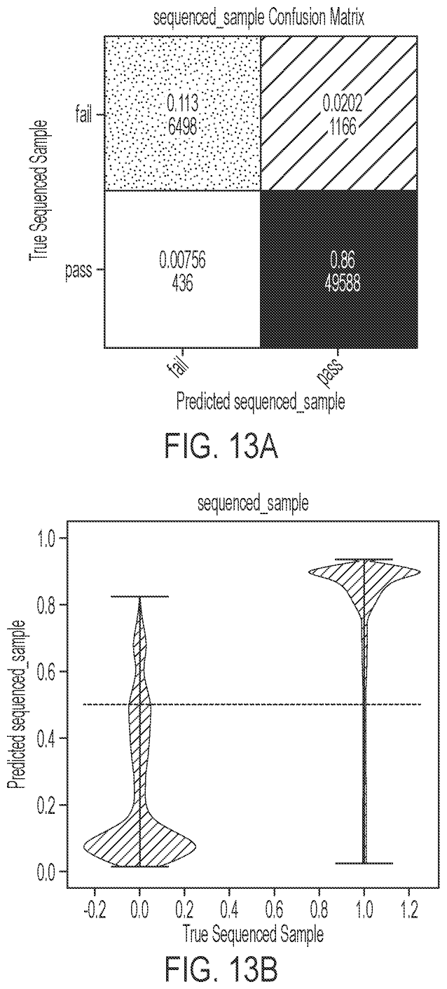

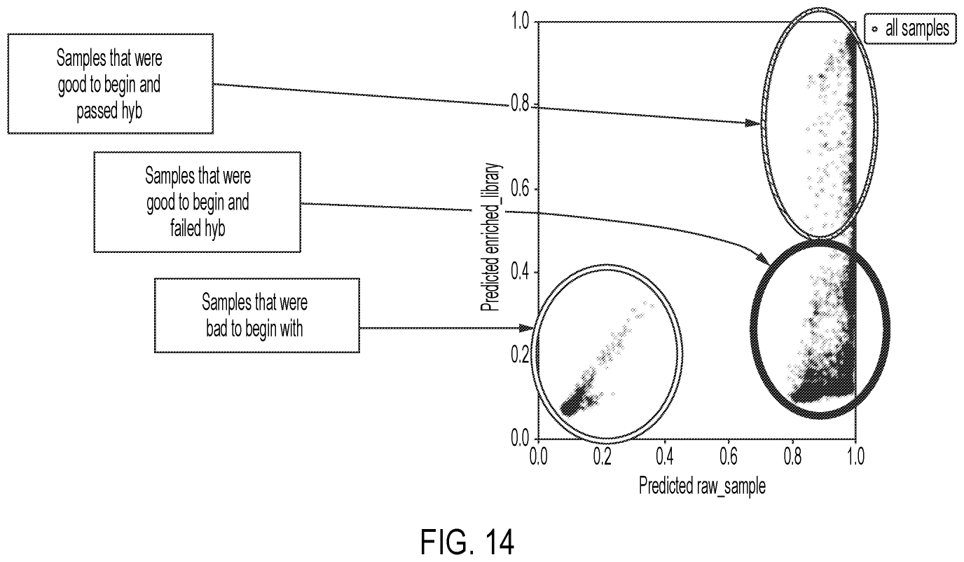

Evaluation of the statistical models described herein may involve comparing predicted status of one or more nodes given values for quality metrics to the true status for the one or more nodes across many biological samples. FIG. 13A is a confusion matrix comparing true sequenced sample status to predicted sequenced sample status determined using a statistical model as described herein. As shown in FIG. 13A, a majority of the samples has the true status and the predicted status be the same, either both as “pass” or both as “fail.” This is also shown in FIG. 13B. FIG. 13B is a plot of true sequenced sample status vs. predicted sequenced sample status determined using a statistical model as described herein.

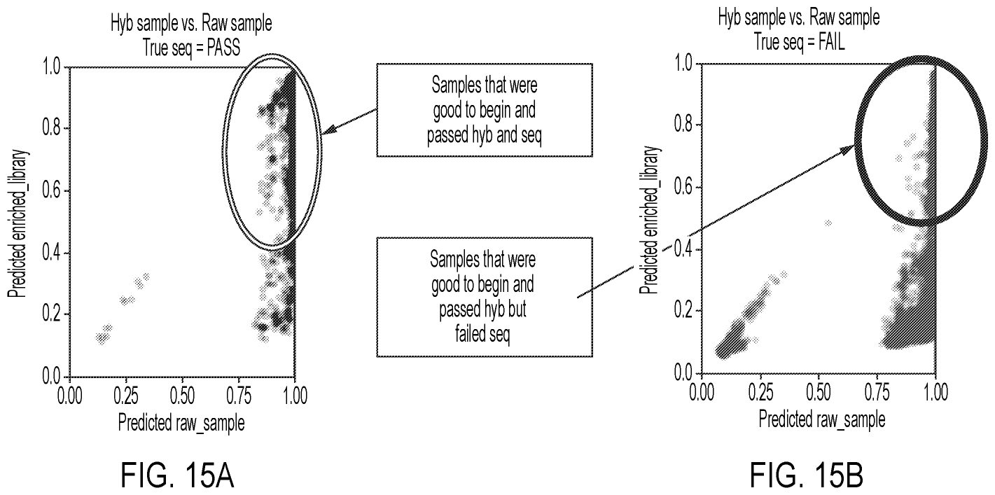

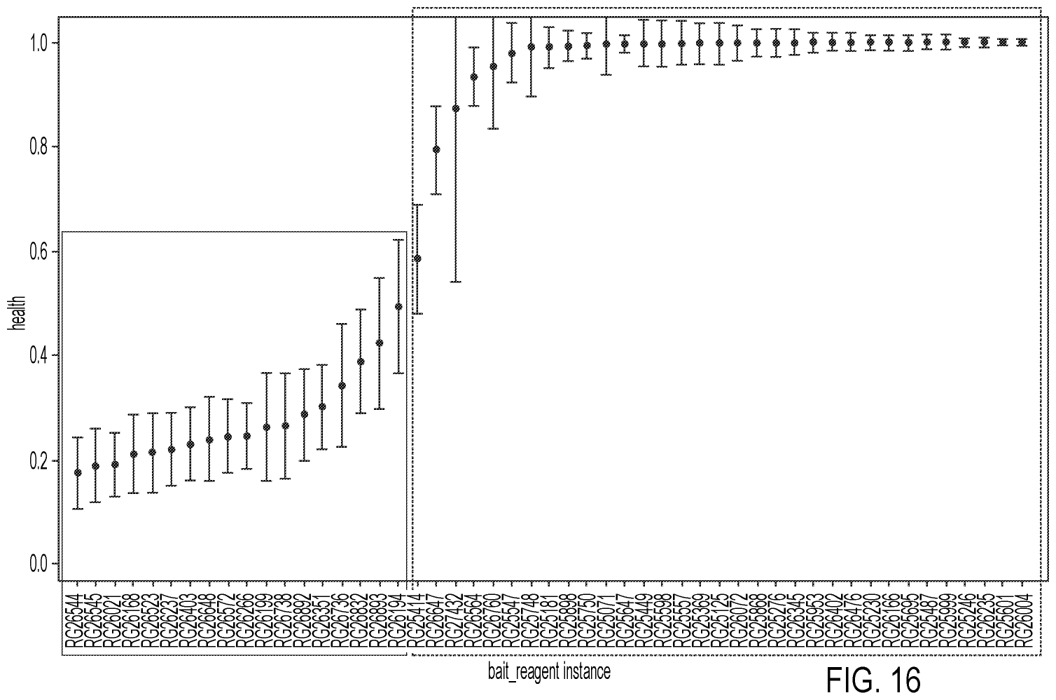

For evaluating a statistical model that represents a hybridization process, predictions for different possible outcomes may be used since there is no truth data for hybridization samples. FIG. 14 is a plot of predicted enriched library vs. predicted raw sample. There are three different regimes circled in FIG. 14. The first is where both the predicted enriched library and the predicted raw sample is high, which corresponds to samples that are both good quality initially and pass hybridization. The second regime is below the first and corresponds to samples that are good quality, but failed hybridization. The third circled regime is where the samples are bad quality. This is further shown in FIGS. 15A and 15B. FIG. 15A is a similar plot as shown in FIG. 14 but includes only the samples that passed a sequencing process. The regime circled in FIG. 15A corresponds to samples that are good quality, passed hybridization, and passed sequencing.

FIG. 15B is a similar plot but includes only the samples that failed the sequencing process. The regime circled in FIG. 15B corresponds to samples that are good quality and passed hybridization, but failed sequencing.

FIG. 16 is a plot of health status for different bait reagents. The statistical model correctly identified the reagents in the box on the left as being a source of error and also correctly identified the in the box on the right were identified as not being a source of error.

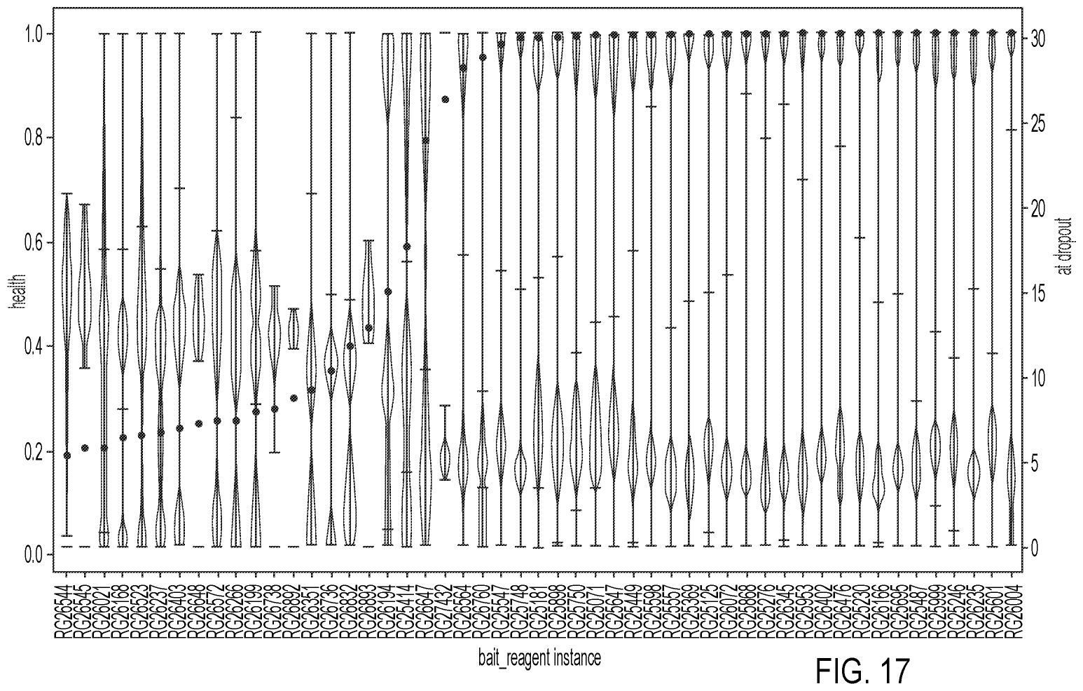

FIG. 17 is also a plot of health status for different bait reagents where the dots are the predicted status for the different bait reagents and the wider regions of the vertical lines are the true status for the different bait reagents. As shown in FIG. 17, most the predicted statuses correspond to the true statuses.

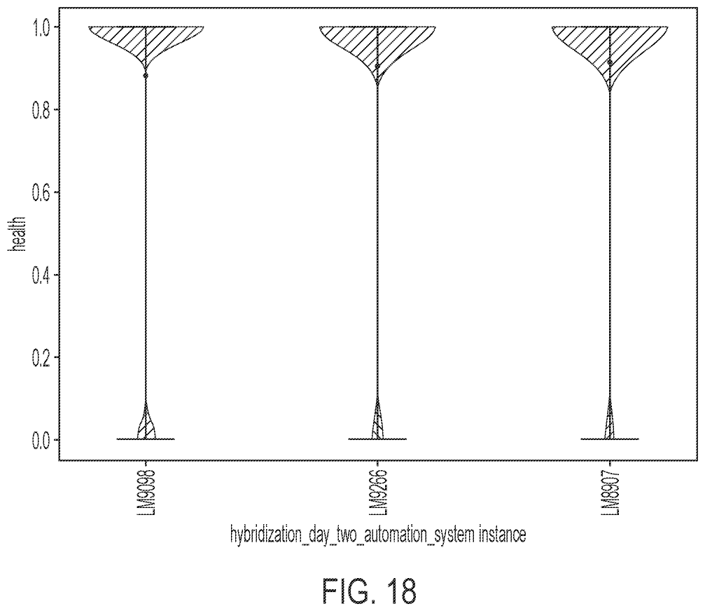

FIG. 18 is a plot of health status for three different hybridization machines. The dots correspond to the predicted status and the wider sections of the vertical lines correspond to the true status. As shown in FIG. 18, the correct status is accurately predicted.

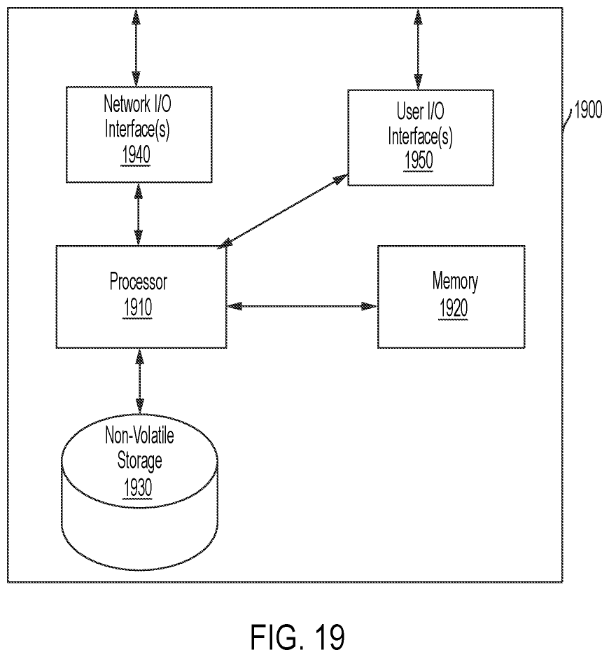

An illustrative implementation of a computer system 1900 that may be used in connection with any of the embodiments of the technology described herein is shown in FIG. 19. The computer system 1900 includes one or more processors 1910 and one or more articles of manufacture that comprise non-transitory computer-readable storage media (e.g., memory 1920 and one or more non-volatile storage media 1930). The processor 1910 may control writing data to and reading data from the memory 1920 and the non-volatile storage device 1930 in any suitable manner, as the aspects of the technology described herein are not limited in this respect. To perform any of the functionality described herein, such as identifying sources of error occurring during processing of biological samples in a laboratory environment using quality metrics and/or graphical modeling, the processor 1910 may execute one or more processor-executable instructions stored in one or more non-transitory computer-readable storage media (e.g., the memory 1920), which may serve as non-transitory computer-readable storage media storing processor-executable instructions for execution by the processor 1910.

Computing device 1900 may also include a network input/output (I/O) interface 1940 via which the computing device may communicate with other computing devices (e.g., over a network), and may also include one or more user I/O interfaces 1950, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The techniques described herein may be implemented in software. In particular, the techniques may be implemented as part of a software application for modeling and/or identifying sources of error in laboratory processes including for processes for biological sample processing, manufacturing, and chemical pipelines. The software application may be implemented in any suitable programming language and may be provided on any suitable platform. For example, the software application may be a web-based application accessible via an Internet browser and/or a dedicated client-side “app” deployed on a user's computing device (e.g., desktop computer, laptop computer, smartphone, table computer, etc.). As another example, the software application may be installed locally on any computing device and used by a user with access to that computing device. As yet another example, the software application may be stored in a cloud-based or other distributed system and accessed via login by a user with an account for the software application. The software application may be configured to implement any of the processes described herein including, but not limited to, the processes described with reference to FIGS. 9, 10, and 11.

In some embodiments, the software application may enable a user to define a laboratory process monitoring project for each one of one or more laboratory processes being monitored. Within each such project, a user may specify a graphical model or any other suitable type of statistical model for modeling the laboratory process. In some embodiments, the user may define nodes in the graphical model that correspond to respective physical components and/or workflow processes that are part of the laboratory process. In some embodiments, the user may define distributions for the root nodes of the graphical model. In some embodiments, the user may define conditional distributions for the nodes in the graphical model that have parent nodes and, in particular, may select the functional form of those conditional distributions from among or more predefined conditional distributions (examples of which are provided herein) and/or specify a new functional form if a distribution other than one of the predefined conditional distributions is desirable.

In some embodiments, the user may define one or quality metrics and/or select from one or more pre-programmed or predefined quality metrics. As part of the software application, the user may specify how the quality metric or metrics are mapped to nodes in the graphical model. For example, the user may specify how the quality metrics are aggregated and, for example, may specify that the aggregation be performed in any of the ways described herein (e.g., by selecting one such way from among a predefined set of options) or by defining a new way of how the aggregation may be performed (e.g., via script or any other suitable interface).

In some embodiments, a user may specify aspects of how statistical inference is to be performed for the graphical model. For example, the user may select an algorithm, from among one or more options, with which statistical inference is to be performed. For a selected algorithm, the user may select one or more parameters and/or configurations, as appropriate.

A user may perform any of the foregoing tasks of defining a laboratory process monitoring project using any suitable interface. For example, the software application may provide the user with a graphical user interface (GUI) for defining graphical models, sequencing metrics, etc. For instance, the software application may provide drag-and-drop interface—a canvas onto which a user may drop GUI elements representing nodes and within which the user can connect various nodes to specify the structure of the graphical model. Each such node or edge may be clickable and may have one or more parameters associated thereto that a user may specify (e.g., by selection from one or more options or by inputting a new parameter value) by interacting with that node/edge in the GUI. Additionally or alternatively, one or more other ways of defining a laboratory process may be provided (e.g., a command line interface, a configuration file, a file of parameter values, importing a pre-existing configuration, etc.).

Additionally or alternatively, all the various tasks described above as being performed by a user may have been previously performed by another (e.g., an administrator or other person) and saved. In turn, the saved definitions (e.g., of a graphical or other statistical model, quality metrics, etc.) may be accessed, used, and/or customized by a user at a later time.

In some embodiments, the software application may be configured to receive data for computing quality metric values and/or already-computed quality metric values. Upon receipt of such data, the software application may automatically (or in response to user input) perform statistical inference to identify sources of error in the laboratory process. In some embodiments, the software application may receive the data and/or already-computed quality metric values after a threshold number of instances of the laboratory process have completed. In other embodiments, the software application may be configured to communicate with one or more computing devices that can provide the software application with access to the data and/or already-computed quality metric values during execution of the laboratory process. In some such embodiments, the software application may provide (e.g., real-time) monitoring functionality and may provide indications of errors occurring (along with information about their potential source) during execution of the laboratory process. This may allow early detection of errors and, where applicable, application of one or more interventions such as stopping a laboratory process from proceeding further where an error has been detected by the software application, causing error information to be provided to a user prior to allowing the laboratory process to proceed, etc. In some embodiments, the software application may be configured to automatically apply the intervention(s) (e.g., by automatically, without user intervention, stopping a laboratory process). In some embodiments, the software application may request confirmation from a user prior to application of the intervention(s).

In some embodiments, the software application may provide one or more graphical user interfaces that provide users with information about errors and/or sources of error in a laboratory process. The GUI(s) may be interactive such that the user can select which information is of interest and obtain more information about the same. For example, the user may select one or more physical component(s) and/or workflow process(es) of interest and the GUI(s) may provide the user with information about those component(s) and/or process(es).

FIG. 20 is a screen shot of an example graphical user interface (GUI) for visualizing health status of a laboratory process over time, as determined using the techniques described herein. In the right portion of the GUI, health status values (y-axis) for one or more physical components of a sample processing workflow are shown over time at different dates (x-axis). This allows a user to visualize how health status of these physical component(s) changes over time and, as more data becomes available, additional health status data may be shown. The left portion of the GUI includes selectable GUI elements (e.g., check boxes). These GUI elements allow a user to select and control what data is visualized in the right portion of the GUI. For example, a user may choose to visualize the progression of health status for sequencing machines only. As another example, a user may choose to visualize the progression of health status for different lots of purification beads. In some embodiments, the user interface may include an option to select a certain number of physical components with the lowest health status values (e.g., the 3, 5, or 10 physical components having the lowest health status). In some embodiments, the user interface may include an option to select the reagents that started to be used most recently in the sample processing workflow. In some embodiments, the user interface may include an option to select which instances of a type of physical component to visualize (e.g., only sequencing machines, only bait mixes). In the example shown, the user has selected to view the evolution over time of the health status of two particular bait mixes.

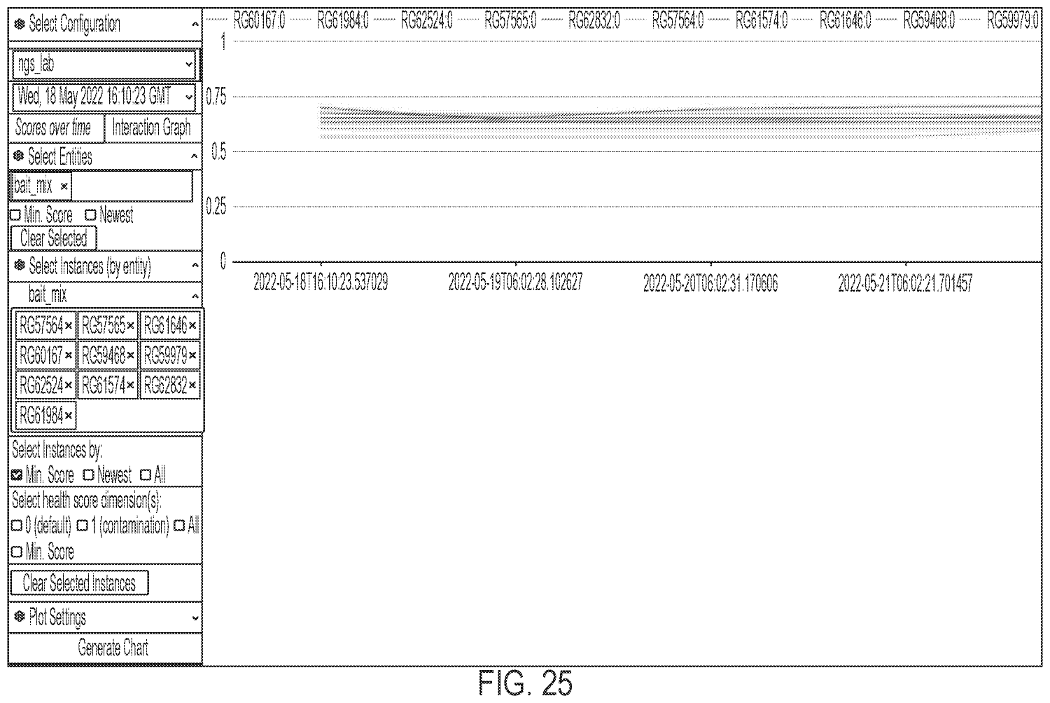

Another example of monitoring health status of multiple components over time is shown in FIG. 25. This figure shows a screenshot of a graphical user interface having two portions. The left portion identifies a number of bait mixes whose health scores are to be monitored and enables users the possibility of specifying one or more other assets to be monitored in addition to or instead of the bait mixes. The right portion shows the health scores of the specified multiple bait mixes over time.

As can also be noted from the example of FIG. 20, the GUI of the software application allows monitoring of the health status of entities (e.g., physical components and/or workflow processes) for different laboratory processes including an NGS workflow process and a COVID workflow process, as two examples. As can also be noted from the example of FIG. 20, a user may create a new project for another laboratory process by clicking the “New config” button at the bottom of the left panel. Doing so will allow the user to specify a workflow graph and other aspects of the configuration for monitoring entities of the other laboratory process.

As can also be noted from the example of FIG. 20, the user may view the workflow graph associated a particular workflow by clicking the GUI element (button) labelled “Show workflow graph”), which will bring the user an interface through which the user can view and/or edit the graphical model embodying the workflow.

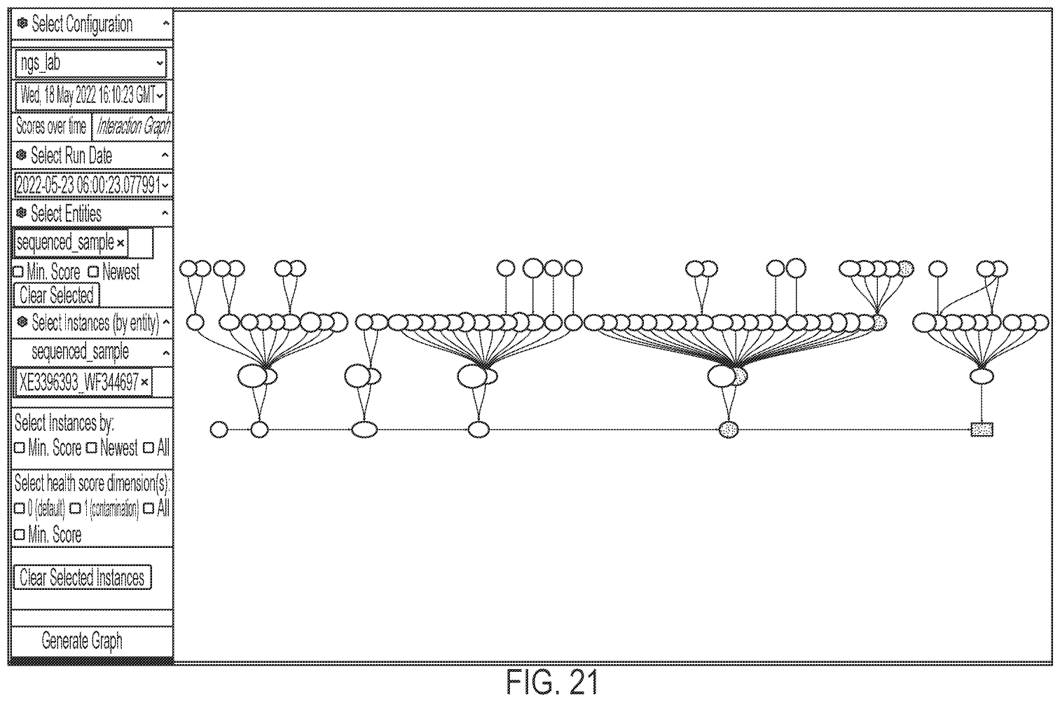

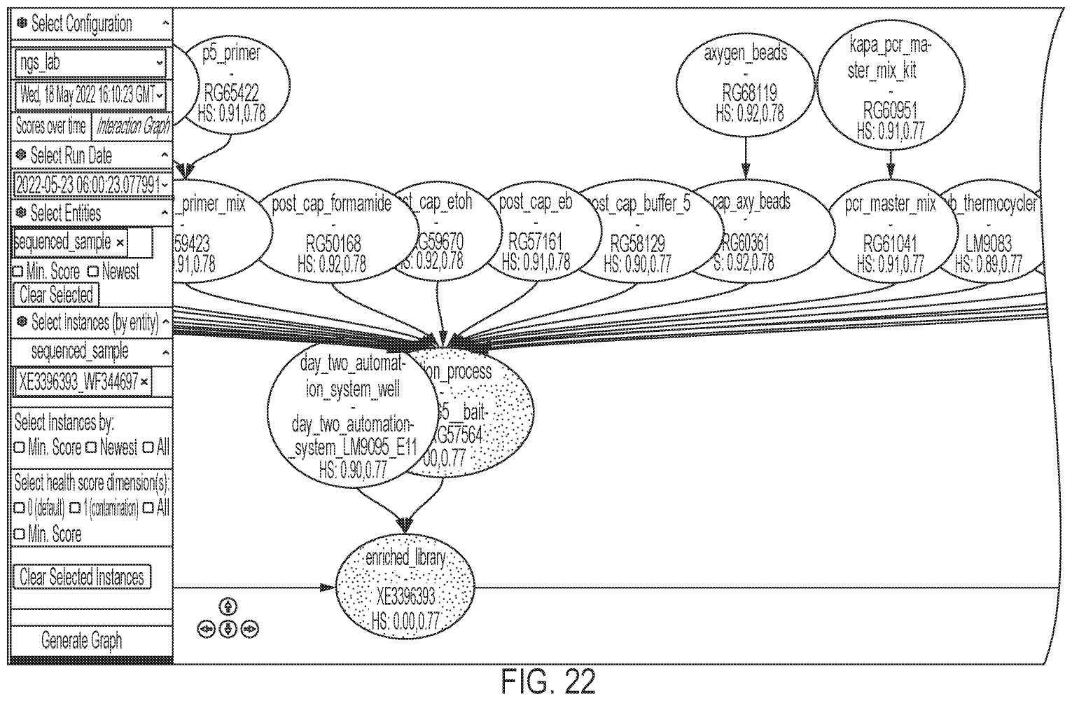

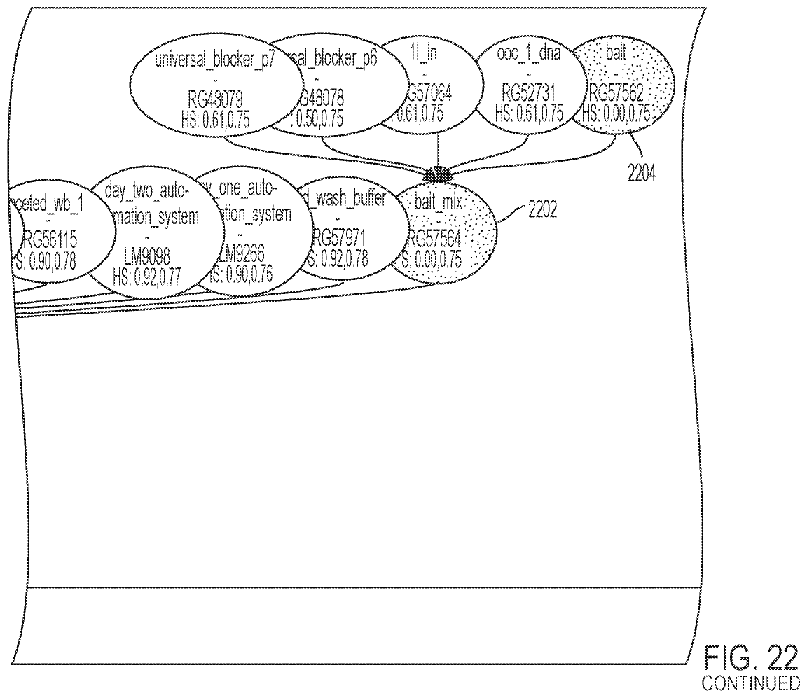

FIGS. 21-23 show an example of a GUI that displays a graphical model used for modeling a next generation sequencing (NGS) workflow. This GUI can help a user identify one or more sources of error in processing a particular sample (which is identified in the left panel). After quality metrics have been computed for the particular sample and statistical inference (e.g., stochastic variation inference) has been performed, the results are shown through the color coding. Nodes colored in red indicate a highly likely source of error (e.g., when the health score of that node is determined by the inference algorithm to be below a first pre-specified or predefined threshold). Nodes colored in yellow indicate a potential source of error (e.g., when the health score of that node is determined by the inference algorithm to be below some second pre-specified or predefined threshold, but not below the first pre-specified or predefined threshold).

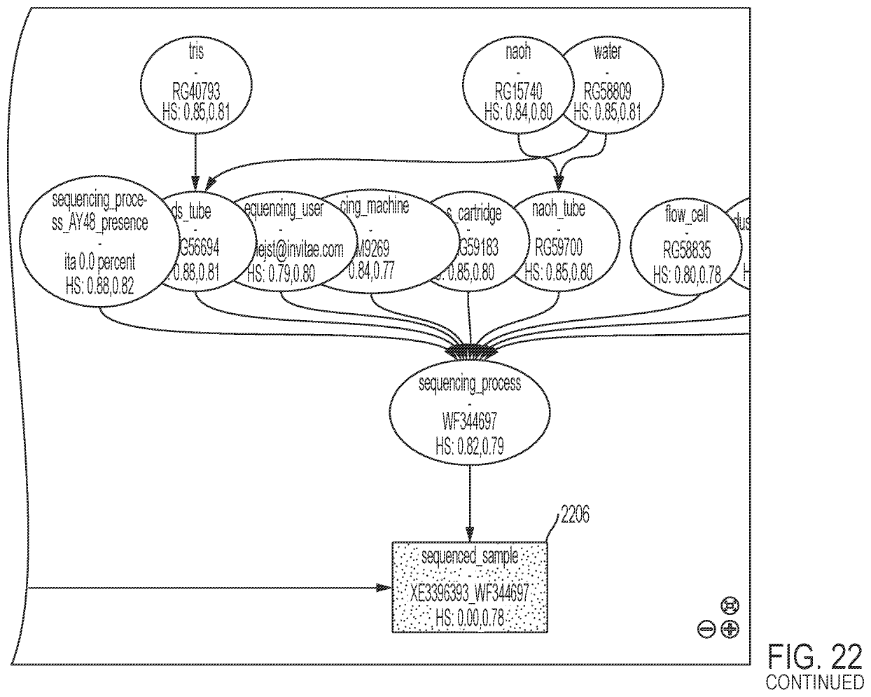

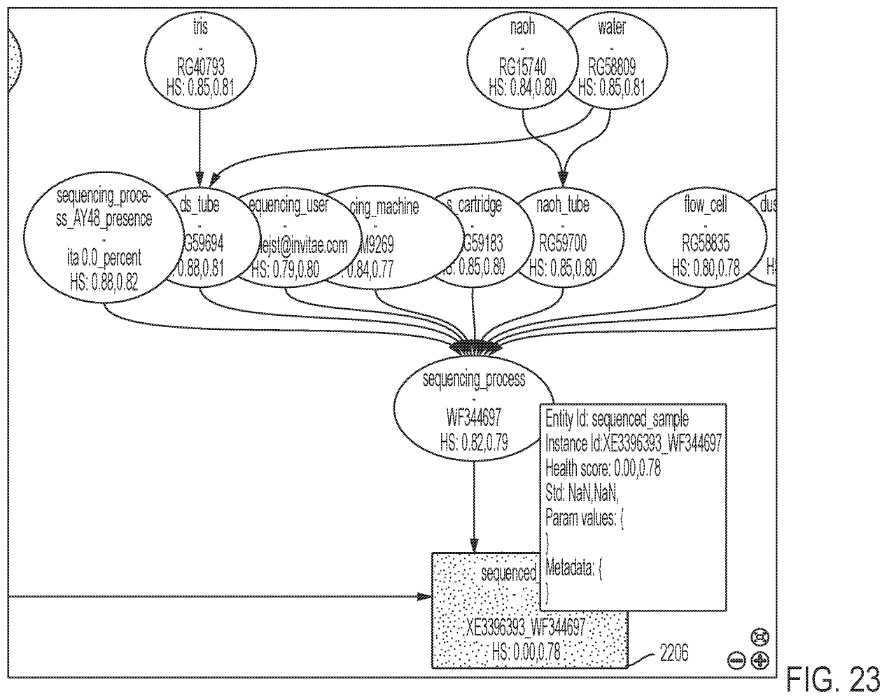

FIG. 22 is a zoomed-in version of FIG. 21. As can be seen in FIG. 22, a particular bait mix, indicated by reference number 2202, may be a source of error for the run and problems with that bait mix likely originated with the bait having ID “RG57562” indicated by reference number 2204. FIG. 23 shows information that may be displayed to a user after a mouse over node 2206 in the graph. In this case, the mouseover shows a health score (0.78) associated with a sequenced sample.

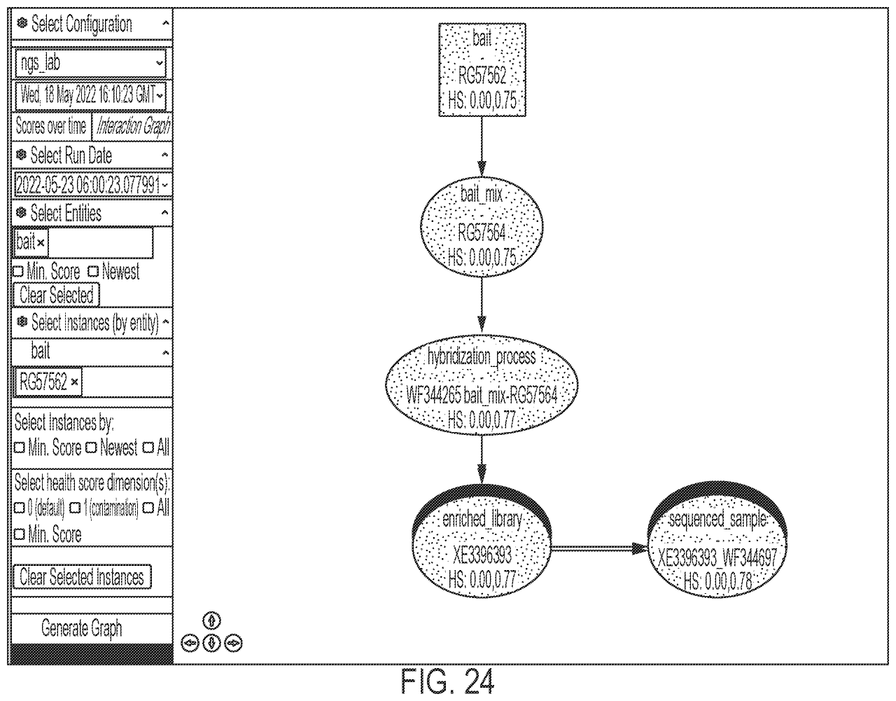

As can be seen from the FIGS. 21-23, the software application may provide a GUI through which a user may look upstream in the workflow to identify one or more potential sources of error in a laboratory process. In some embodiments, the GUI may also allow a user to look “downstream” to explore how an error in a particular point of a laboratory process can affect downstream steps in the process. For example, as shown in FIG. 24, a user may view the downstream effects of a problem with a particular bait having ID “RG57562”. Such upstream and downstream views allow a user to easily identify one or more sources of error in a workflow and take ameliorative steps.

It should be appreciated that the GUIs shown in FIGS. 20-25 are merely illustrative and that other GUIs, for example with different arrangements of GUI portions and/or formats for visualizing the data, may be employed.

The above-described embodiments can be implemented in any of numerous ways. For example, the embodiments may be implemented using hardware, software, or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-described functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-described functions of one or more embodiments. The computer-readable medium may be transportable such that the program stored thereon can be loaded onto any computing device to implement aspects of the techniques described herein. In addition, it should be appreciated that the reference to a computer program which, when executed, performs any of the above-described functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques described herein.

The terms “program” or “software” are used herein in a generic sense to refer to any type of computer code or set of processor-executable instructions that can be employed to program a computer or other processor to implement various aspects of embodiments as described above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

The described embodiments can be implemented in various combinations, including the below configurations.

(1) A method for identifying sources of error occurring during processing of biological samples in a laboratory environment in accordance with a sample processing workflow, the sample processing workflow being performed using one or more physical components and/or one or more workflow processes, the sample processing workflow being associated with at least one quality metric, the method comprising: using at least one computer hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more sources of error for the data generated by processing the plurality of biological samples, the identifying performed using the values of the at least one quality metric and a statistical model representing causal relationships among the one or more physical components and/or the one or more workflow processes used to perform the sample processing workflow; and outputting information indicative of the identified one or more sources of error.

(2) The method of (1), wherein the information indicative of the identified one or more sources of error indicates a physical component, from among the one or more physical components used to perform the sample processing workflow, as a source of error for the data generated by processing the plurality of biological samples in accordance with the sample processing workflow.

(3) The method of (2), wherein the physical component is a piece of equipment used to perform at least one workflow process of the sample processing workflow, and outputting information further comprises outputting information identifying the piece of equipment.

(4) The method of (2), wherein the physical component is a reagent from a lot used to perform at least one workflow process of the sample processing workflow, and outputting information further comprises outputting information identifying the lot as a source of error for the data generated by processing the plurality of biological samples in accordance with the sample processing workflow.

(5) The method of any of (1)-(4), wherein the information indicative of the identified one or more sources of error indicates a workflow process, from among the one or more workflow processes used to perform the sample processing workflow, as a source of error for the data generated by processing the plurality of biological samples in accordance with the sample processing workflow.

(6) The method of any of (1)-(5), wherein the information indicative of the identified one or more sources of error indicates one or more of the plurality of biological samples as a source of error for the data generated by processing the plurality of biological samples in accordance with the sample processing workflow.

(7) The method of any of (1)-(6), further comprising processing the plurality of biological samples in accordance with the sample processing workflow.

(8) The method of any of (1)-(7), wherein the one or more physical components include one or more reagents used in the sample processing workflow and/or one or more pieces of equipment used in the sample processing workflow.

(9) The method of (8), wherein the one or more physical components include at least one physical component selected from the group consisting of: an extraction machine, an extraction automation system, a library preparation automation system, a thermocycler, an automation system, a sequencing machine, a hybridization machine, a centrifugation machine, a liquid handling system, and a qPCR machine.

(10) The method of (8) or (9), wherein the one or more physical components include at least one reagent selected from the group consisting of: a buffer, a binding buffer, a wash buffer, an organic reagent, an inorganic reagent, an acidic solution, and a basic solution.

(11) The method of any one of (8)-(10), wherein the one or more physical components include at least one selected from the group consisting of: a bait mix, a hybridization mix, a sequencing mix, a PCR master mix, and a primer mix.

(12) The method of any one of (8)-(11), wherein the one or more physical components include at least one selected from the group consisting of: an enzyme, a labeled nucleotide, a sample plate, enrichment beads, a flow cell, a cartridge, a pipette, a pipette tip, and a sample tube.

(13) The method of any one of (8)-(12), wherein the one or more workflow processes include at least one workflow process selected from the group consisting of: an extraction process, a library preparation process, an enrichment process, a hybridization process, a sequencing process, a centrifugation process, an assay setup process, an amplification process, and a qPCR process.

(14) The method of any one of (8)-(13), wherein the one or more workflow processes include a sequencing process, the one or more physical components include at least one sequencing machine and at least one sequencing reagent, the data includes sequencing data for each of the at least some of the plurality of biological samples, and the at least one quality metric includes sequencing metrics for the sequencing data.

(15) The method of (14), wherein the statistical model represents causal relationships among the at least one sequencing machine, the at least one sequencing reagent, the plurality of biological samples, and the sequencing data.

(16) The method of any one of (1)-(15), wherein the one or more workflow processes include a hybridization process and the one or more physical components include at least one hybridization reagent and at least one hybridization machine.

(17) The method of (16), wherein the statistical model represents causal relationships among the at least one hybridization reagent, the at least one hybridization machine, the plurality of biological samples, and hybridization samples corresponding to the plurality of biological samples.

(18) The method of any one of (1)-(17), wherein the data includes data generated during performance and/or at completion of the sample processing workflow.

(19) The method of any one of (1)-(18), wherein the data includes data generated for one of the one or more workflow processes of the sample processing workflow.

(20) The method of any of (1)-(19), wherein the at least one quality metric comprises a plurality of quality metrics, and the identifying is performed using the statistical model and values of an aggregate metric computed using values for the plurality of quality metrics. The aggregate metric may be a single value or a plurality of values each of which is determined by aggregating quality metric values in a respective plurality of groups of quality metric values (each such group having one or multiple quality metric values).

(21) The method of (20), wherein a value of the aggregate metric for a biological sample is computed by calculating a product of the values of the plurality of quality metrics determined for the biological sample, calculating a minimum of the values of the plurality of quality metrics, or calculating a soft-minimum of the values of the plurality of quality metrics

(22) The method of any one of (1)-(21), wherein the statistical model comprises a graphical model comprising: nodes representing random variables corresponding to at least some of the one or more physical components and/or at least some of the one or more workflow processes; and directed edges representing causal relationships among the at least some of the one or more physical components and/or the at least some of the one or more workflow processes.

(23) The method of (22), wherein the graphical model further comprises nodes representing observable random variables corresponding to results obtained by performing at least part of the sample processing workflow for the plurality of biological samples.

(24) The method of (22) or (23), wherein the nodes comprise separate nodes corresponding to different biological samples connected to a common node corresponding to a common physical component or workflow process used to perform the sample processing workflow for the different biological samples.

(25) The method of (24), wherein a node corresponding to a workflow process performed as part of the sample processing workflow is connected to two or more of the one or more physical components used in performing the workflow process.

(26) The method of any one of (22)-(25), wherein the graphical model comprises a Bayesian network.

(27) The method of any one of (22)-(26), wherein a node corresponding to a physical component of the sample processing workflow represents a random variable whose value is indicative of a degree to which the physical component contributes to error in the data generated by processing biological samples in accordance with the sample processing workflow.

(28) The method of any one of (22)-(27), wherein a node corresponding to a workflow process of the sample processing workflow represents a random variable whose value is indicative of a degree to which the workflow process contributes to error in the data generated by processing biological samples in accordance with the sample processing workflow.

(29) The method of any one of (22)-(28), wherein the nodes represent continuous-valued 0-1 random variables distributed in accordance with a Beta distribution, a normal distribution, or a sigmoid distribution.

(30) The method of any one of (22)-(29), wherein identifying the one or more sources of error comprises determining an estimate of a posterior distribution of one or more of the random variables represented by the nodes in the graphical model given the values of the at least one quality metric.

(31) The method of (30), wherein determining the estimate is performed using a stochastic variational inference technique.

(32) A system for identifying sources of error occurring during processing of biological samples in a laboratory environment in accordance with a sample processing workflow, the sample processing workflow being performed using one or more physical components and/or one or more workflow processes, the sample processing workflow being associated with at least one quality metric, the system comprising: at least one hardware processor; and at least one non-transitory computer-readable storage medium storing processor-executable instructions that, when executed by the at least one hardware processor, cause the at least one hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more sources of error for the data generated by processing the plurality of biological samples, the identifying performed using the values of the at least one quality metric and a statistical model representing causal relationships among the one or more physical components and/or the one or more workflow processes used to perform the sample processing workflow; and outputting information indicative of the identified one or more sources of error.

(33) At least one non-transitory computer-readable storage medium storing processor-executable instructions that, when executed by at least one hardware processor, cause the at least one hardware processor to perform a method for identifying sources of error occurring during processing of biological samples in a laboratory environment in accordance with a sample processing workflow, the sample processing workflow being performed using one or more physical components and/or one or more workflow processes, the sample processing workflow being associated with at least one quality metric, the method comprising: using at least one computer hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more sources of error for the data generated by processing the plurality of biological samples, the identifying performed using the values of the at least one quality metric and a statistical model representing causal relationships among the one or more physical components and/or the one or more workflow processes used to perform the sample processing workflow; and outputting information indicative of the identified one or more sources of error.

(34) A computer program comprising computer executable instructions which when executed by at least one processor cause the at least one processor to perform the steps of any one of the preceding methods of (1)-31.

(35) The computer program of (34), wherein the computer program is embodied in a computer readable medium.

(36) A method for identifying attributes for one or more physical components and/or one or more workflow processes of a sample processing workflow, the sample processing workflow being performed using the one or more physical components and/or the one or more workflow processes, the sample processing workflow being associated with at least one quality metric, the method comprising: using at least one computer hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more attributes for the one or more physical components and/or the one or more workflow processes, the identifying performed using the values of the at least one quality metric and a graphical model comprising nodes representing random variables corresponding to the one or more physical components and/or the one or more workflow processes, each of at least some of the nodes representing a random variable whose value is indicative of a degree to which a physical component or a workflow process contributed to error in the data generated by processing the plurality of biological samples in accordance with the sample processing workflow; and outputting information indicative of the identified one or more attributes.

(37) The method of (36), wherein the identified one or more attributes includes an attribute for a physical component indicating whether the physical component is a source of error.

(38) The method of (36) or (37), wherein the identified one or more attributes includes an attribute for a physical component indicating whether the physical component needs service.

(39) The method of any one of (36)-(38), wherein the graphical model further comprises nodes representing observable random variables corresponding to results obtained by performing at least part of the sample processing workflow for the plurality of biological samples.

(40) The method of any one of (36)-(39), wherein the nodes comprise separate nodes corresponding to different biological samples connected to a common node corresponding to a common physical component or workflow process used to perform the sample processing workflow for the different biological samples.

(41) The method of any one of (36)-(40), wherein a node corresponding to a workflow process performed as part of the sample processing workflow connects to two or more of the one or more physical components used in performing the workflow process.

(42) The method of any one of (36)-(41), wherein the graphical model comprises a Bayesian network.

(43) A system for identifying conditions for one or more physical components and/or one or more workflow processes of a sample processing workflow, the sample processing workflow being performed using the one or more physical components and/or the one or more workflow processes, the sample processing workflow being associated with at least one quality metric, the system comprising: at least one hardware processor; and at least one non-transitory computer-readable storage medium storing processor-executable instructions that, when executed by the at least one hardware processor, cause the at least one hardware processor to perform: obtaining data about a plurality of biological samples, the data generated by processing the plurality of biological samples in accordance with the sample processing workflow; determining, using the data, values of the at least one quality metric for each of at least some of the plurality of biological samples; identifying one or more attributes for the one or more physical components and/or the one or more workflow processes, the identifying performed using the values of the at least one quality metric and a graphical model comprising nodes representing random variables corresponding to the one or more physical components and/or the one or more workflow processes, each of at least some of the nodes representing a random variable whose value is indicative of a degree to which a physical component or a workflow process contributed to error in the data generated by the sample processing workflow; and outputting information indicative of the identified one or more attributes.

(44) At least one non-transitory computer-readable storage medium storing processor-executable instructions that, when executed by at least one hardware processor, cause the at least one hardware processor to perform a method for identifying conditions for one or more physical components and/or one or more workflow processes of a sample processing workflow, the sample processing workflow being performed using the one or more physical components and/or the one or more workflow processes, the sample processing workflow being associated with at least one quality metric, the method comprising: obtaining data about a plurality of biological samples, the data generated by processing the plurality of biological samples in accordance with the sample processing workflow; determining, using the data, values of the at least one quality metric for each of at least some of the plurality of biological samples; identifying one or more attributes for the one or more physical components and/or the one or more workflow processes, the identifying performed using the values of the at least one quality metric and a graphical model comprising nodes representing random variables corresponding to the one or more physical components and/or the one or more workflow processes, each of at least some of the nodes representing a random variable whose value is indicative of a degree to which a physical component or a workflow process contributed to error in the data generated by the sample processing workflow; and outputting information indicative of the identified one or more attributes.

(45) A computer program comprising computer executable instructions which when executed by at least one processor cause the at least one processor to perform the steps of any one of the preceding methods of (36)-(42).

(46) The computer program of (45), wherein the computer program is embodied in a computer readable medium.

(47) A method for monitoring attributes of one or more physical components and/or one or more workflow processes used in performing a sample processing workflow, the sample processing workflow being associated with at least one quality metric, the method comprising: using at least one computer hardware processor to perform: obtaining first data about a first plurality of biological samples, the first data generated by processing the first plurality of biological samples in accordance with the sample processing workflow; determining, using the first data, first values of the at least one quality metric for each of at least some of the first plurality of biological samples; identifying, using the first values of the at least one quality metric and a statistical model, one or more first attributes for the one or more physical components and/or the one or more workflow processes; obtaining second data about a second plurality of biological samples, the second data generated by processing the second plurality of biological samples in accordance with the sample processing workflow; determining, using the second data, second values of the at least one quality metric for each of at least some of the second plurality of biological samples; identifying, using the second values of the at least one quality metric and the statistical model, one or more second attributes for the one or more physical components and/or the one or more workflow processes; and detecting a change in a physical component or a workflow process of the sample processing workflow based on the identified one or more first attributes and the identified one or more second attributes.

(48) The method of (47), wherein the statistical model represents causal relationships among the one or more physical components and/or the one or more workflow processes used to perform the sample processing workflow.

(49) The method of (47) or (48), wherein the method further comprises outputting information indicative of the change in the physical component or the workflow process.

(50) The method of any one of (47)-(49), wherein the detected change indicates a physical component of the sample processing workflow needs service.

(51) The method of any one of (47)-(50), wherein the first plurality of biological samples is processed using the sample processing workflow during a first time period and the second plurality of biological samples is processed using the sample processing workflow during a second time period.

(52) A system for monitoring attributes of one or more physical components and/or one or more workflow processes used in performing a sample processing workflow, the sample processing workflow being associated with at least one quality metric, the system comprising: at least one hardware processor; and at least one non-transitory computer-readable storage medium storing processor-executable instructions that, when executed by the at least one hardware processor, cause the at least one hardware processor to perform: obtaining first data about a first plurality of biological samples, the first data generated by processing the first plurality of biological samples in accordance with the sample processing workflow; determining, using the first data, first values of the at least one quality metric for each of at least some of the first plurality of biological samples; identifying, using the first values of the at least one quality metric and a statistical model, one or more first attributes for the one or more physical components and/or the one or more workflow processes; obtaining second data about a second plurality of biological samples, the second data generated by processing the second plurality of biological samples in accordance with the sample processing workflow; determining, using the second data, second values of the at least one quality metric for each of at least some of the second plurality of biological samples; identifying, using the second values of the at least one quality metric and the statistical model, one or more second attributes for the one or more physical components and/or the one or more workflow processes; and detecting a change in a physical component or a workflow process of the sample processing workflow based on the identified one or more first attributes and the identified one or more second attributes.

(53) At least one non-transitory computer-readable storage medium storing processor-executable instructions that, when executed by at least one hardware processor, cause the at least one hardware processor to perform a method for monitoring attributes of one or more physical components and/or one or more workflow processes used in performing a sample processing workflow, the sample processing workflow being associated with at least one quality metric, the method comprising: obtaining first data about a first plurality of biological samples, the first data generated by processing the first plurality of biological samples in accordance with the sample processing workflow; determining, using the first data, first values of the at least one quality metric for each of at least some of the first plurality of biological samples; identifying, using the first values of the at least one quality metric and a statistical model, one or more first attributes for the one or more physical components and/or the one or more workflow processes; obtaining second data about a second plurality of biological samples, the second data generated by processing the second plurality of biological samples in accordance with the sample processing workflow; determining, using the second data, second values of the at least one quality metric for each of at least some of the second plurality of biological samples; identifying, using the second values of the at least one quality metric and the statistical model, one or more second attributes for the one or more physical components and/or the one or more workflow processes; and detecting a change in a physical component or a workflow process of the sample processing workflow based on the identified one or more first attributes and the identified one or more second attributes.

(54) A computer program comprising computer executable instructions which when executed by at least one processor cause the at least one processor to perform the steps of any one of the preceding methods of (47)-(51).

(55) The computer program of (54), wherein the computer program is embodied in a computer readable medium.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method for identifying sources of error occurring during processing of biological samples in a laboratory environment in accordance with a sample processing workflow, the sample processing workflow being performed using one or more physical components and/or one or more workflow processes, the sample processing workflow being associated with at least one quality metric, the method comprising:
using at least one computer hardware processor to perform:
obtaining data about a plurality of biological samples, the data generated by processing the plurality of biological samples in accordance with the sample processing workflow;
determining, using the data, values of the at least one quality metric for each of at least some of the plurality of biological samples;
identifying one or more sources of error for the data generated by processing the plurality of biological samples, the identifying performed using the values of the at least one quality metric and a statistical model representing causal relationships among the one or more physical components and/or the one or more workflow processes used to perform the sample processing workflow; and
outputting information indicative of the identified one or more sources of error.

2. The method of claim 1, wherein the information indicative of the identified one or more sources of error indicates a physical component, from among the one or more physical components used to perform the sample processing workflow, as a source of error for the data generated by processing the plurality of biological samples in accordance with the sample processing workflow.

3. The method of claim 2, wherein the physical component is a piece of equipment used to perform at least one workflow process of the sample processing workflow, and outputting information further comprises outputting information identifying the piece of equipment.

4. The method of claim 2, wherein the physical component is a reagent from a lot used to perform at least one workflow process of the sample processing workflow, and outputting information further comprises outputting information identifying the lot as a source of error for the data generated by processing the plurality of biological samples in accordance with the sample processing workflow.

5. The method of claim 1, wherein the information indicative of the identified one or more sources of error indicates a workflow process, from among the one or more workflow processes used to perform the sample processing workflow, as a source of error for the data generated by processing the plurality of biological samples in accordance with the sample processing workflow.

6. The method of claim 1, wherein the information indicative of the identified one or more sources of error indicates one or more of the plurality of biological samples as a source of error for the data generated by processing the plurality of biological samples in accordance with the sample processing workflow.

7. The method of claim 1, further comprising processing the plurality of biological samples in accordance with the sample processing workflow.

8. The method of claim 1, wherein the one or more physical components include one or more reagents used in the sample processing workflow and/or one or more pieces of equipment used in the sample processing workflow.

9. The method of claim 8, wherein the one or more physical components include at least one physical component selected from the group consisting of: an extraction machine, an extraction automation system, a library preparation automation system, a thermocycler, an automation system, a sequencing machine, a hybridization machine, a centrifugation machine, a liquid handling system, and a qPCR machine.

10. The method of claim 8, wherein the one or more physical components include at least one reagent selected from the group consisting of: a buffer, a binding buffer, a wash buffer, an organic reagent, an inorganic reagent, an acidic solution, and a basic solution.

11. The method of claim 8, wherein the one or more physical components include at least one selected from the group consisting of: a bait mix, a hybridization mix, a sequencing mix, a PCR master mix, and a primer mix.

12. The method of claim 8, wherein the one or more physical components include at least one selected from the group consisting of: an enzyme, a labeled nucleotide, a sample plate, enrichment beads, a flow cell, a cartridge, a pipette, a pipette tip, and a sample tube.

13. The method of claim 8, wherein the one or more workflow processes include at least one workflow process selected from the group consisting of: an extraction process, a library preparation process, an enrichment process, a hybridization process, a sequencing process, a centrifugation process, an assay setup process, an amplification process, and a qPCR process.

14. The method of claim 8, wherein the one or more workflow processes include a sequencing process, the one or more physical components include at least one sequencing machine and at least one sequencing reagent, the data includes sequencing data for each of the at least some of the plurality of biological samples, and the at least one quality metric includes sequencing metrics for the sequencing data.

15. The method of claim 14, wherein the statistical model represents causal relationships among the at least one sequencing machine, the at least one sequencing reagent, the plurality of biological samples, and the sequencing data.

16-21. (canceled)

22. The method of claim 1, wherein the statistical model comprises a graphical model comprising:
nodes representing random variables corresponding to at least some of the one or more physical components and/or at least some of the one or more workflow processes; and
directed edges representing causal relationships among the at least some of the one or more physical components and/or the at least some of the one or more workflow processes.

23-27. (canceled)

27. The method of claim 22, wherein a node corresponding to a physical component of the sample processing workflow represents a random variable whose value is indicative of a degree to which the physical component contributes to error in the data generated by processing biological samples in accordance with the sample processing workflow.

28. The method of claim 22, wherein a node corresponding to a workflow process of the sample processing workflow represents a random variable whose value is indicative of a degree to which the workflow process contributes to error in the data generated by processing biological samples in accordance with the sample processing workflow.

29-31. (canceled)

32. A system for identifying sources of error occurring during processing of biological samples in a laboratory environment in accordance with a sample processing workflow, the sample processing workflow being performed using one or more physical components and/or one or more workflow processes, the sample processing workflow being associated with at least one quality metric, the system comprising:
at least one hardware processor; and
at least one non-transitory computer-readable storage medium storing processor-executable instructions that, when executed by the at least one hardware processor, cause the at least one hardware processor to perform:
obtaining data about a plurality of biological samples, the data generated by processing the plurality of biological samples in accordance with the sample processing workflow;
determining, using the data, values of the at least one quality metric for each of at least some of the plurality of biological samples;
identifying one or more sources of error for the data generated by processing the plurality of biological samples, the identifying performed using the values of the at least one quality metric and a statistical model representing causal relationships among the one or more physical components and/or the one or more workflow processes used to perform the sample processing workflow; and
outputting information indicative of the identified one or more sources of error.

33. At least one non-transitory computer-readable storage medium storing processor-executable instructions that, when executed by at least one hardware processor, cause the at least one hardware processor to perform a method for identifying sources of error occurring during processing of biological samples in a laboratory environment in accordance with a sample processing workflow, the sample processing workflow being performed using one or more physical components and/or one or more workflow processes, the sample processing workflow being associated with at least one quality metric, the method comprising:
using at least one computer hardware processor to perform:
obtaining data about a plurality of biological samples, the data generated by processing the plurality of biological samples in accordance with the sample processing workflow;
determining, using the data, values of the at least one quality metric for each of at least some of the plurality of biological samples;
identifying one or more sources of error for the data generated by processing the plurality of biological samples, the identifying performed using the values of the at least one quality metric and a statistical model representing causal relationships among the one or more physical components and/or the one or more workflow processes used to perform the sample processing workflow; and
outputting information indicative of the identified one or more sources of error.

34.-55. (canceled)
